(19) United States
(12) Patent Application Publication
(10) Pub. No.: US 2008/0315748 A1
(43) Pub. Date: Dec. 25, 2008

(54) Display Device

(76) Inventors: Takaaki Kitada, Oamishirasato (JP); Takashi Naito, Funabashi (JP); Shigemi Hirasawa, Chiba (JP); Akira Hatori, Chiba (JP); Shoji Shirai, Mobara (JP); Shunichi Asakura, Sakae (JP); Makoto Yano, Mito (JP); Yuuichi Kijima, Chosei (JP); Nobuhiko Hosotani, Mobara (JP); Go Saito, Mobara (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/054,427

(22) Filed: Mar. 25, 2008

(30) Foreign Application Priority Data
Mar. 30, 2007 (JP) 2007-091764
May 9, 2007 (JP) 2007-124837
May 9, 2007 (JP) 2007-124934
Aug. 29, 2007 (JP) 2007-222488
Aug. 31, 2007 (JP) 2007-226308

(51) Int. Cl. H01J 29/90

(52) U.S. Cl. 313/477 HC

(57) ABSTRACT

There is disclosed an FED (field emission display) capable of supplying an anode voltage, which is a high voltage, to an anode substrate with high reliability. A high voltage introduction button is sealed to a sealing plate, in which a contact spring is attached to the high voltage introduction button by spot welding. The high voltage introduction button has a flat portion connected to the contact spring, a sealing portion sealed to the glass substrate, and an external terminal to be connected to an external power source. The contact spring contacts an anode terminal of an anode substrate with an appropriate contact pressure, by a spring force from an arm portion of the contact spring. The anode terminal is formed of a conductive film containing metal particles.

### CLAIM OF PRIORITY

The present application claims priority from Japanese Application JP 2007-091764 filed on Mar. 30, 2007, Japanese Application JP 2007-124934 filed on May 9, 2007, Japanese Application JP 2007-124837 filed on May 9, 2007, Japanese Application JP 2007-222488 filed on Aug. 29, 2007, Japanese Application JP 2007-226308 filed on Aug. 31, 2007, the content of which is hereby incorporated by references into this application.

### FIELD OF THE INVENTION

The present invention relates to a display device, and more particularly, to a flat display device having an interior maintained at a vacuum, including a rear substrate with electron emission sources arranged in a matrix form, and a front substrate with phosphors arranged in a corresponding manner.

### BACKGROUND OF THE INVENTION

A field emission display (FED) having an interior that is defined between two glass substrates and maintained at a vacuum, in which electron emission sources are arranged on one substrate in a matrix form, and phosphors are arranged on the opposite substrate. In the FED, the phosphors emit light by bombardment of electrons from the electron emission sources, and then an image is formed. The FED is able to obtain excellent brightness, contrast, and video characteristics that are equivalent to those of a cathode-ray tube, and thereby expected to be a feature TV display.

However, in the FED, a high voltage of about 10 KV should be applied to the anode to accelerate the electrons so that the phosphors emit light. Supplying such a high voltage of 10 KV to one substrate with sufficient reliability is a difficult problem, and thus various devices and inventions have been disclosed. Examples of the method of supplying such a high voltage are disclosed in JP-A No. 1998-31433, JP-A No. 1998-326581, JP-A No. 2000-311636, JP-A No. 2003-115271, and JP-A 1993-114372. These patent documents disclose a method of sealing a high voltage introduction terminal, the use of a coil spring or a plate spring as a method of contacting a high voltage introduction terminal and an anode, and the like, which have not been put into practice yet.

### SUMMARY OF THE INVENTION

In the above described related art, a high voltage introduction terminal is provided on the side of a substrate opposite to an anode substrate to which a high voltage is applied, namely, on the side of a cathode substrate. The high voltage is supplied to the anode substrate through a coil spring or plate spring, and the like, which is attached to the high voltage introduction terminal. In the case of a coil spring, there remains a problem with the reliability of the connection between the coil spring and the high voltage introduction terminal, or the contact between the coil spring and the anode. The use of the coil spring has another problem that when a large current flows through the coil spring, the coil is reduced by electromagnetic force, preventing the contact between the anode and the coil spring.

While the use of a plate-like spring has a problem of instability of the contact between an end of the plate spring and a voltage supply terminal of the anode substrate. In other words, in the case of a typical plate spring, the contact between the anode terminal and the plate spring is a point contact, causing a problem of conduction failure as a result of repeating ON and OFF operation.

The coil spring or the plate spring and the like should contact the anode substrate, posing a problem of instability in the contact portion. There is another problem that a spark occurs due to the shape of parts in the vicinity of a terminal for introducing a high voltage, or other factors.

The present invention has been devised in order to overcome the above problems of the related art, and to supply a high voltage to an anode substrate with a high reliability.

The present invention aims to solve the above problems, which is briefly described as follows.

According to the present invention, a high voltage introduction terminal is embedded into a cathode substrate, in which the high voltage introduction terminal and a contact spring are connected to each other. On the side of an anode substrate that the contact spring contacts, there is provided a conductor such as silver paste to realize a high voltage introduction method with a high reliability.

According to an aspect of the present invention, a high voltage introduction button having a disk-like shape with a depth or having a cylindrical shape with a closed bottom, is provided in the cathode substrate or the anode substrate by frit glass, or is directly fused to the glass. The high voltage introduction button is used as means of introducing a high voltage.

According to another aspect of the present invention, an anode terminal is formed in the anode substrate by using a sintered film of silver paste with silver particles and silver flakes dispersed in a frit glass containing vanadium oxide as a main component, thereby causing no environmental contamination due to lead. The silver particles and silver flakes are used to be able to provide reliable conductivity to a metal back. Further, the anode terminal has a specific film thickness and shape in order to prevent partial peeling-off or other defects in the anode terminal.

According to still another aspect of the present invention, a thin plate of a metal with a thermal expansion coefficient close to the glass is used for the anode terminal. According to a first embodiment of the present invention, a thin plate of an Fe—Ni alloy with a thermal expansion coefficient matched to the glass is used for the anode terminal. Thus, there is no possibility that the contact spring is bonded to the glass. As a result, it is possible to supply a high voltage to the anode substrate with a high reliability.

According to still another aspect of the present invention, the shape of the contact spring and its surface roughness are determined by specific values, in order to prevent deterioration of the withstand voltage characteristics due to the contact spring.

According to still another aspect of the present invention, the contact spring is applied with a high voltage. The relationship between the contact spring and an internal component of an FED is determined by a specific value, in order to reduce the possibility of a spark.

According to still another aspect of the present invention, the shape of the anode electrode formed in the anode substrate, namely, the metal back is defined in an appropriate manner, in order to reduce the possibility of a spark due to the anode substrate.

According to the present invention, the contact spring is used for supplying a high voltage, so that it is possible to supply the high voltage to the anode substrate with a high reliability. Also, according to the present invention, it is possible to sufficiently maintain the air tightness with the glass plate in the high voltage introduction terminal portion.

Further, according to the present invention, it is possible to ensure the reliability of the anode terminal of the anode substrate that the contact spring contacts. Still further, according to the present invention, it is possible to prevent a spark from occurring between the parts including the contact spring used in the high voltage introduction portion, or between the structures.

### BRIEF DESCRIPTION OF THE DRAWINGS

FIG. 1 is a plan view to which the present invention is applied;

FIG. 2 is a side vide of FIG. 1;

FIG. 3 is a partial cross-sectional view of FIG. 1;

FIG. 4 is a cross-sectional view of a substantial portion of a first example;

FIG. 5 is a partial plan view of the first example;

FIG. 6 is a side view of FIG. 5;

FIG. 7 is a cross-sectional view of FIG. 5;

FIG. 8 is a perspective view showing the shape of a contact spring of the first example;

FIGS. 9A, 9B are cross-sectional views showing a contact portion of the contract spring of FIG. 8;

FIGS. 10A, 10B are cross-sectional views showing another contract portion of the contract spring;

FIG. 11 is a perspective view showing the shape of another contact spring;

FIGS. 12A, 12B are cross-sectional views showing a contact portion of the contact spring of FIG. 11;

FIGS. 13A, 13B are cross-sectional views showing another contact portion of the contact spring of FIG. 11;

FIGS. 14A, 14B are another example of the contact spring according to the present invention;

FIG. 15 is a cross-sectional view of a substantial portion of a second embodiment of the first example;

FIG. 16 is a partial plan view of FIG. 15;

FIG. 17 is a side view of FIG. 16;

FIG. 18 is a cross-sectional view of FIG. 16;

FIG. 19 is a perspective view showing the shape of a contact spring of the second embodiment of the first example;

FIG. 20 is a cross-sectional view of a substantial portion of a third embodiment of the first example;

FIG. 21 is a partial plan view of the third embodiment of the first example;

FIG. 22 is a side view of FIG. 21;

FIG. 23 is another side view of FIG. 21;

FIG. 24 is a perspective view showing another example of the shape of the contact spring;

FIG. 25 is a cross-sectional view of a substantial portion of the third embodiment of the first example;

FIG. 26 is a cross-sectional view of a first embodiment of a second example;

FIG. 27 is a contact spring assembly of FIG. 26;

FIGS. 28A to 28C are detailed views of the contact spring assembly of FIG. 26;

FIG. 29 is a cross-sectional view of a second embodiment of the second example;

FIG. 30 is a perspective view showing the shape of the contact spring of FIG. 29;

FIG. 31 is a cross-sectional view of a third embodiment of the second example;

FIG. 32 is a perspective view showing the shape of the contact spring of FIG. 32;

FIG. 33 is a cross-sectional view of a fourth embodiment of the second example;

FIGS. 34A to 34C show the shape of a high voltage introduction button;

FIG. 35 is a cross-sectional view showing another example of the fourth embodiment of the second example;

FIGS. 36A, 36B are views of a high voltage introduction terminal;

FIG. 37 is a cross-sectional view of a fifth embodiment of the second example;

FIG. 38 is a cross-sectional view of a sixth embodiment of the second example;

FIG. 39 is a partial enlarged plan view of an anode substrate;

FIGS. 40A, 40B are examples of a silver particle;

FIGS. 41A, 41B are examples of a flake-like silver particle;

FIGS. 42A to 42C show the shape of an anode terminal;

FIGS. 43A to 43C show another shape of the anode terminal;

FIG. 44 shows still another shape of the anode terminal;

FIG. 45 is a cross-sectional view of a substantial portion of a second embodiment of a third example;

FIG. 46 is a plan view showing the vicinity of the anode terminal of the second embodiment of the third example;

FIGS. 47A, 47B are an example of a metal disk-shaped anode terminal;

FIG. 48 is a cross-sectional view of a substantial portion of a first embodiment of a fourth example;

FIG. 49 is a perspective view of a contact spring assembly used in FIG. 48;

FIG. 50 is a perspective view of the contact spring used in FIG. 48;

FIGS. 51A to 51D are detailed views of the contact spring;

FIG. 52 is a detailed view of an end portion of the contact spring;

FIG. 53 is another example of the contact spring;

FIG. 54 is still another example of the contact spring;

FIG. 55 is a cross-sectional view of a substantial portion of a first embodiment of a fifth example;

FIG. 56 is a detailed plan view of a high voltage introduction portion of a cathode substrate;

FIG. 57 is a plan view of an anode substrate;

FIGS. 58A to 58D are plan views of the high voltage introduction portion according to the present invention, in the anode substrate; and

FIGS. 59A to 59D are another example of the plan views of the high voltage introduction portion according to the present invention, in the anode substrate.

### DETAILED DESCRIPTION OF THE PREFERRED EMBODIMENTS

Hereinafter, preferred embodiments of the present invention will be described in detail with reference to the accompanying drawings.

### First Example

### First Embodiment

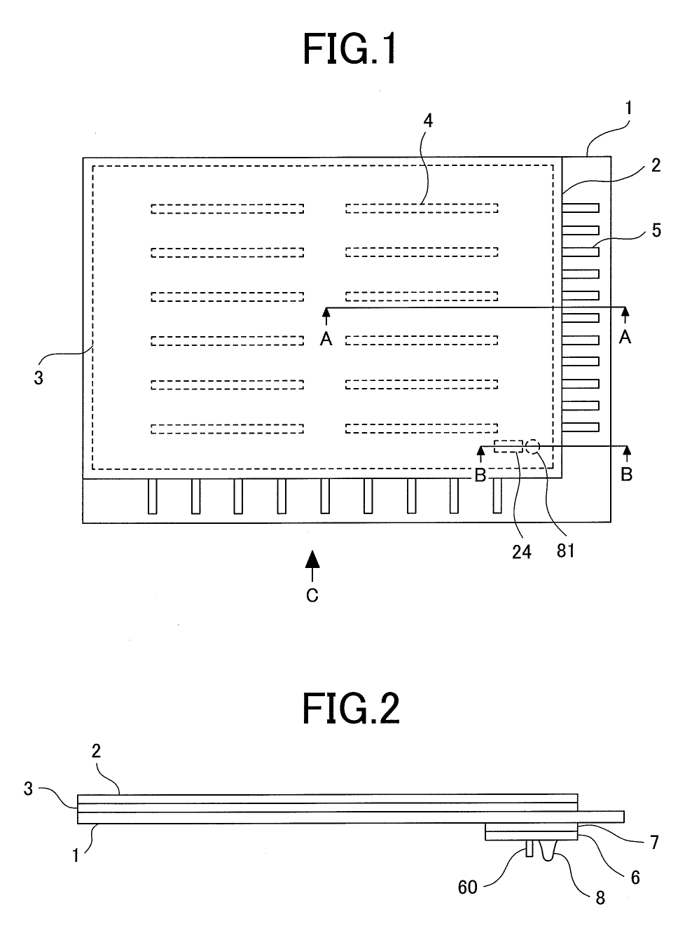

FIG. 1 is a plan view showing an FED to which the present invention is applied. In FIG. 1, an anode substrate 2 is provided above a cathode substrate 1 through a sealing portion 3. On the cathode substrate there are provided scan lines extending in the horizontal direction, as well as data signal lines extending in the vertical direction. The scan lines and the data signal lines are supplied with signals from the outside through terminals 5. Electron emission sources are provided in the vicinity of the intersections of the scan lines and the signal lines. In other words, a large number of electron emission sources are arranged in a matrix form. Various types of electron emission source have been developed, such as so-called MIM-type, SID-type, and Spindt-type, all of which can be applied to the embodiment.

The interior, which is defined by the cathode substrate 1, the anode substrate 2, and the surrounding sealing portion 3, is maintained at a vacuum. In such a configuration, the anode substrate 2 and the cathode substrate 1 are distorted by the atmosphere, and the distance between the cathode substrate 1 and the anode substrate 2 is not maintained. Or possibly the cathode substrate 1 or the anode substrate 2 is destroyed. In order to avoid this, spacers 4 are provided between the cathode substrate 1 and the anode substrate 2. The spacer 4 is formed of ceramic or glass, and is generally provided on the scan line so as not to prevent image formation.

On the anode substrate, there are formed red, green, and blue phosphors that emit light by bombardment of electron beams, at positions corresponding to the electron emission sources. A black matrix (BM) is formed among the phosphors to improve the contrast of an image. A metal back of Al is formed covering the black matrix. When the metal back is applied with a high voltage, the electron beams from the cathode are accelerated and bombard phosphors 21.

The electron beam should have certain energy in order to emit light from the phosphors. Thus, the metal back of the anode substrate 2 is applied with a high voltage of 8 KV to 10 KV. In the embodiment, a high voltage introduction terminal 60 is provided on the cathode substrate side in order to receive the high voltage supplied from the outside. The high voltage is supplied to the anode substrate 2 through a contract spring. In FIG. 1, an anode terminal 24 in which the contact spring and the anode substrate are brought into contact is formed in a corner portion of a display device. In order to ensure that the interior of the display device is maintained at a vacuum, an exhaust hole 81 for evacuation is formed in the corner portion of the display device as shown in FIG. 1.

FIG. 2 is a side view seen from the C direction in FIG. 1. In FIG. 2, the cathode substrate 1 and the anode substrate 2 face each other with a predetermined distance through the sealing portion 3. The cathode substrate 1 is formed larger than the anode substrate 2, for the terminals 5 and the like provided in the cathode substrate 1. On the lower side of the cathode substrate 1 there is provided an exhaust plate 6 to attach an exhaust tube 8 and a high voltage introduction terminal 60. The exhaust plate 6 is attached to the cathode substrate 1 through an exhaust plate sealing portion 7. FIG. 2 shows a state in which the exhaust tube 8 for evacuating the interior of the display device is chipped off in the exhaust plate 6. The high voltage introduction terminal 60 is attached in the vicinity of the exhaust tube 8.

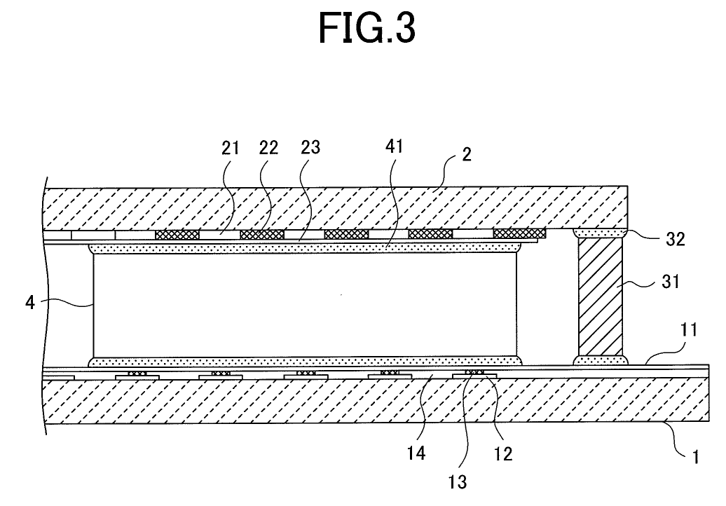

FIG. 3 is an A-A cross-sectional view of FIG. 1. In FIG. 3, data signal lines 12 extend vertically to the drawing surface. In the embodiment, electron emission sources 13 are formed on the data signal lines 12. A scan line 11 is formed in the direction orthogonal to the data signal lines 12 through an insulating film 14. In FIG. 3, the scan line 11 extends to the outside of the sealing portion 3. The spacer 4 is provided on the scan line 11 to maintain a distance between the cathode substrate 1 and the anode substrate 2. The spacer 4 is fixed to the scan line on the cathode substrate side and to a metal back 23 on the anode substrate side, using a fixing material 41. The spacer 4 is provided with conductivity of about 10⁸ to 10⁹ ohms, preventing the charging of the spacer 4 by a small current flowing between the cathode and the anode.

On the anode substrate side, the phosphors 21 of red, green, blue or other colors are provided at positions corresponding to the electron emission sources 13. The phosphors 21 emit light by bombardment of electron beams, and then an image is formed. The BM 22 is filled between the phosphors 21 and contributes to improve the contrast of the image. The BM 22 has, for example, a two-layer structure of a chrome layer and a chrome oxide layer. The metal back 23 of Al is formed covering the phosphors 21 and the BM 22. The metal back 23 is applied with a high voltage of about 8 KV to 10 KV to accelerate the electron beams. The accelerated electron beams bombard the phosphors 21 through the metal back 23, and then the phosphors 21 emit light. Since the high voltage is applied to the metal back 23, a reliable high voltage supply is important for the present example.

In order to maintain the interior of the display device at a vacuum, the cathode substrate 1 and the anode substrate 2 are sealed by a frame 31 and the sealing 32. Here, the frit glass is used as the sealing 32. The thickness of the cathode substrate 1 and the anode substrate 2 is about 3 mm. The distance between the cathode substrate 1 and the anode substrate 2 is about 2.8 mm. The interior of the display device is a high electric field.

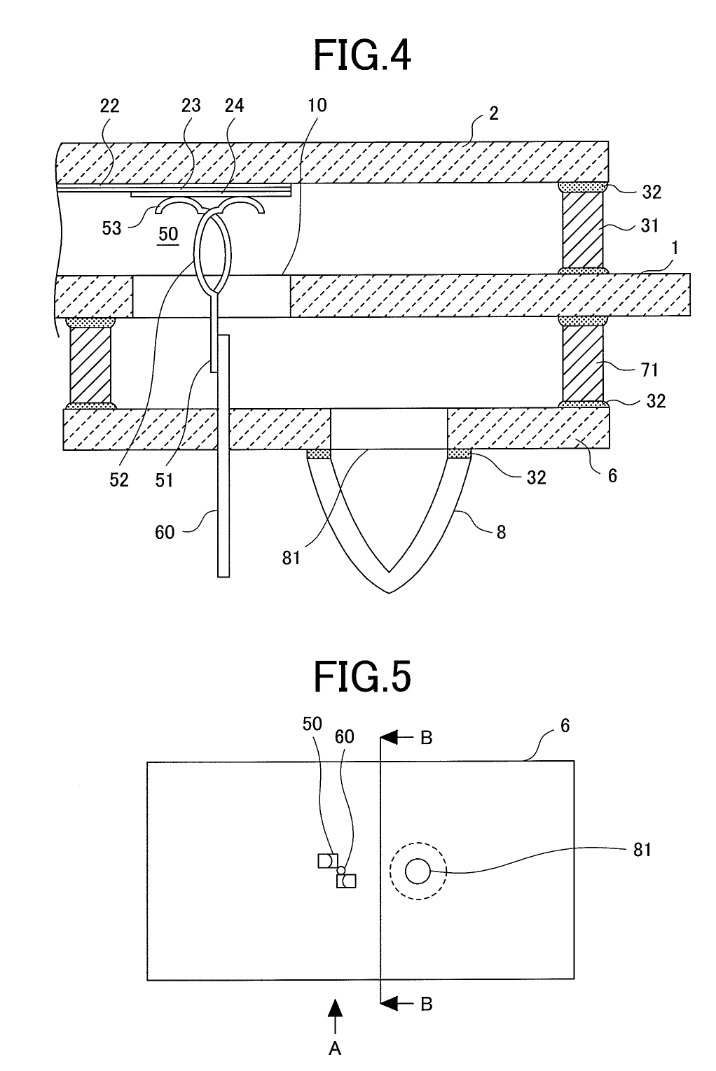

FIG. 4 is a B-B cross-sectional view of FIG. 1, which shows a substantial portion of the first embodiment. In FIG. 4, a through hole 10 is formed in the cathode substrate 1. The evacuation of the display device, or the high voltage supply is performed through the through hole 10. The exhaust plate 6 is provided covering the through hole 10 of the cathode substrate 1 via the exhaust plate sealing portion 7. In this way, the interior of the display device is maintained at a vacuum. The basic configuration of the exhaust plate sealing portion 7 is the same as that of the sealing portion 3 for sealing the cathode substrate 1 and the anode substrate 2. In other words, an exhaust plate frame 71 is sealed to the cathode substrate 1 and to the anode substrate 2 through the sealing 32. In the embodiment, the thickness of the frame 31 for sealing the anode substrate 2 and the cathode substrate 1 is set equal to the thickness of the frame for sealing the cathode substrate 1 and the exhaust plate 6. However, the thickness of the frames can be freely set according to the necessity.

The high voltage introduction terminal 60 passes through the exhaust plate 6 while maintaining air tightness against the outside. The high voltage introduction terminal 60 is embedded into the exhaust plate 6 at the same time when the exhaust plate 6 is formed from a glass material. An Fe—Ni alloy of φ1 mm is used as a material of the high voltage introduction terminal. The ratio of Fe and Ni is determined by taking into account the thermal expansion of the exhaust plate 6. In the embodiment, the content of Ni is 48%. A contact spring 50 is spot welded to the high voltage introduction terminal 60.

The contact spring 50 includes a base portion 51 connected to the high voltage introduction terminal 60, an arm portion 52, and a contact portion 53. Upon bending of the arm portion 52 of the contact spring 50, a bending stress is applied to the contact portion 53 of the contact spring 50. Then the contact portion 53 contacts the metal back formed in the anode substrate 2 with an appropriate force. The contact portion 53 of the contact spring 50 is an appropriate curve, such as a sphere, able to stably contact the metal back 23. Taking into account the heat resistance or other relevant characteristics, Inconel is used as a material of the contact spring 50.

The anode terminal 24 for contacting the contact spring 50 is formed in the anode substrate 2. Since relatively large current flows through the anode terminal 24, its reliability is important. In the embodiment, the configuration in the vicinity of the anode terminal 24 is as follows. That is, the BM 22 of chrome and chrome oxide is formed in the anode substrate. The metal back 23 of Al is formed covering the BM 22. This is the same configuration as the effective surface of a screen. In the embodiment, a conductive film having a thickness of 10 μm to 30 μm is formed as the anode terminal on the metal back 23. In the embodiment, silver paste is applied by printing or other means, followed by baking and then forming the conductive film. There is no need to provide a specific process for baking the conductive film. The baking of the conductive film can be simultaneously done, for example, in the baking process for fixing the spacer 4.

The silver paste contains silver particles having a diameter of 1 micron to several μm and being dispersed in an organic solvent with high viscosity. The sliver particles are bonded together after baking, and then the conductive film has conductivity. Sometimes the conductive film may have a certain resistance. In such a case, it is possible to adjust the resistance by further mixing frit glass paste with the normal silver paste. Incidentally, the material of the conductive film is not limited to the silver paste, and other pastes may also be used, such as Ni paste with Ni particles dispersed therein, or Al paste with Al particles dispersed therein. It is possible to increase the resistance of the conductive film formed of the metal paste, by mixing the frit glass and the like with the metal paste. Further, a black lead film bonded by a binder can also be used as the conductive film. In this case, the black lead is preferably graphite. It is possible to increase the resistance of the black lead conductive film, for example, by mixing colcothar (iron oxide) or frit glass and the like with the black lead.

By forming a thick conductive film having a thickness of 10 μm to 30 μm, the contact between the contact spring 50 and the conductive film can be stabilized. In other words, in the case of using a metal film, the contact between the contact spring 50 and the metal film is a point contact. The current is concentrated at the point contact portion in which the conductive film is very likely to be destroyed. However, in the case of using the conductive film according to the embodiment, the conductive film and the contact spring 50 can contact each other in an area larger than using the metal film. In this case, their contact is nearly in a surface contact state and is stabilized. Further, the conductive film according to the embodiment has a larger resistance than the metal, and is able to prevent a large current from flowing through the contact portion. From this point, the stability of the contact conductivity can also be improved.

The exhaust hole 81 is formed in the exhaust plate 6. The exhaust tube 8 is provided in the exhaust hole 81 through the frit glass as the sealing 32. The interior of the display device is evacuated to vacuum through the exhaust tube 8. Then, the exhaust tube 8 is chipped off to maintain the interior of the display device at a vacuum. FIG. 4 shows the state in which the exhaust tube 8 is chipped off.

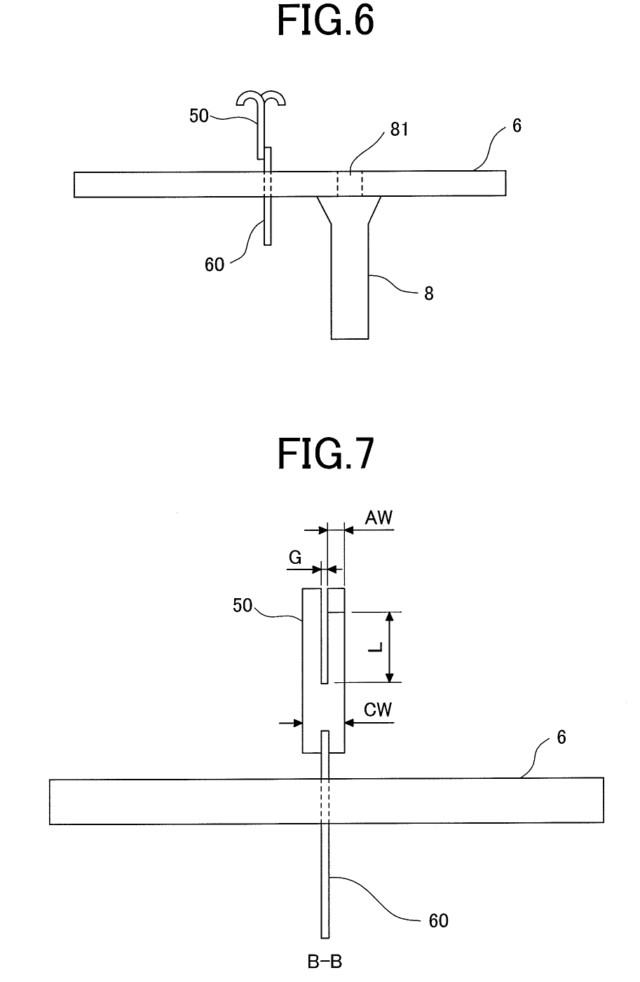

FIG. 5 is a plan view showing the state before the exhaust plate 6 is attached to the cathode substrate 1. FIG. 6 is a side view seen from the A direction in FIG. 5. The exhaust hole 81 is provided in the exhaust plate 6 through which the high voltage introduction terminal 60 passes. The contact spring 50 is attached to the high voltage introduction terminal 60 by spot welding. On the back side of the exhaust plate 6, the exhaust tube 8 is attached by the frit glass. After the interior of the display device is evacuated to vacuum, the exhaust tube 8 is chipped off to seal the display device.

FIG. 7 is a B-B cross-sectional view of FIG. 5. The figure shows the state in which the contact spring 50 is attached to the high voltage introduction terminal 60 passing through the exhaust plate 6. The contact spring 50 includes: the base portion 51 connected to the high voltage introduction terminal 60; the arm portion 52 for providing an appropriate contact pressure by a bending stress due to the bending of the arm portion 52 when the contact spring 50 contacts the metal back 23; and the contact portion 53 for contacting the anode substrate 2. The shape of the contact spring 50 according to the embodiment is as follows.

The width CW of the contact spring 50 is 5 mm. The arm portion 52 is divided into two parts. Each part of the arm portion 52 is designed to bend in an opposite direction when the contact spring 50 contacts the anode substrate 2. The width AW of each part of the arm portion is 2 mm, the gap G between the two divided parts of the arm portion is 1 mm, and the arm length L is about 10 mm. The material of the contact spring 50 is Inconel having a thickness of 0.1 mm. In the embodiment, the contact pressure due to the bending of the arm portion 52 when the contact spring 50 contacts the anode substrate 2 is about 10 g.

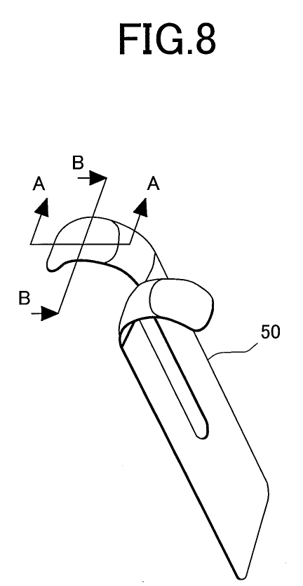

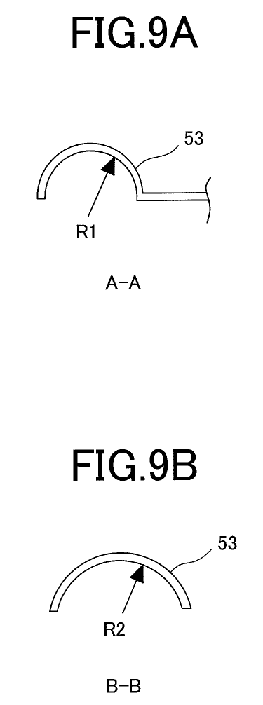

FIG. 8 is a detailed view of the contact spring 50. In FIG. 8, the contact portion 53 of the contact spring 50 for contacting the metal back 23 is a pseudo sphere. In the embodiment, the contact portion 53 of the contact spring 50 is not a perfect sphere. As shown in FIG. 8, the curvature radius is different in the length direction and width direction of the contact spring 50. FIG. 9A is an A-A cross sectional view of FIG. 8, and FIG. 9B is a B-B cross-sectional view of FIG. 8. As shown in FIGS. 9A, 9B, the curvature radius R1 in the length direction of the contact spring 50 is smaller than the curvature radius R2 in the width direction thereof. The curvature radius in the length direction is made smaller so that the contact spring 50 can contact and slide on the anode substrate 2 more smoothly. However, the contact area can be increased with a larger curvature radius. The width direction does not have much effect on the sliding or other movement in the contact of the contact spring 50. Thus, the embodiment focuses on increasing the curvature radius to ensure the contact area with the metal back 23. In the embodiment, for example, the curvature radius R1 is 2 mm, and the curvature radius R2 is 5 mm. It is needless to say that R1 and R2 may have the same value to form a perfect sphere depending on the design.

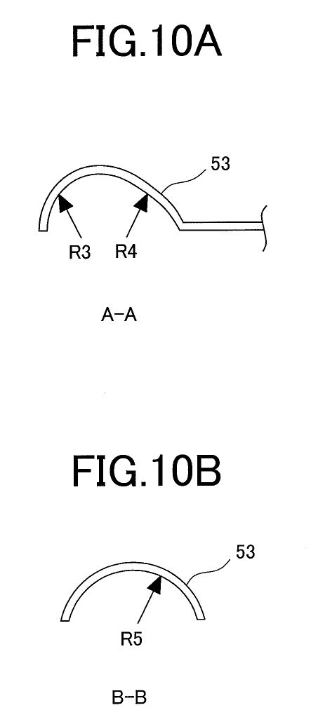

FIGS. 10A, 10B are another example of the contact spring 50. FIG. 10A is an A-A cross-sectional view of FIG. 8, and FIG. 10B is a B-B cross-sectional view of FIG. 8. In FIGS. 10A, 10B, the curvature radius in the length direction of the contact portion 53 of the contact spring 50 is changed in the end portion and in the root portion. In other words, the curvature radius R3 of the end portion is made smaller than the curvature radius R4 of the root portion. This allows the contact spring 50, upon contacting the metal back 23, to contact and slide on the anode terminal more smoothly. Further, in the example of FIGS. 10A, 10B, the curvature radius R5 in the width direction of the contact spring 50 is different from the curvature radius in the length direction of the contact spring 50. Preferably R5 is larger than R3. However, the relationship in size between R4 and R5 can be changed appropriately, depending on the internal configuration of the display device.

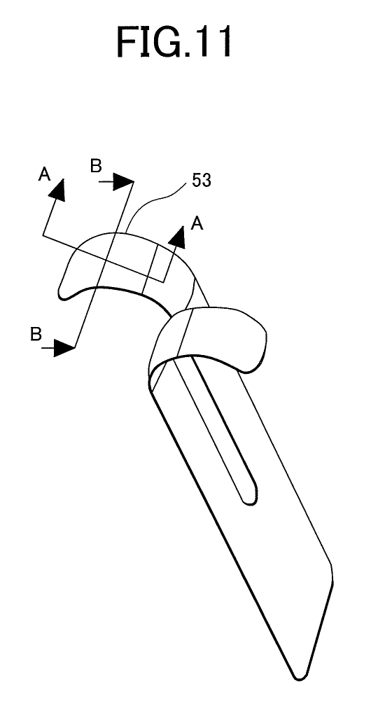

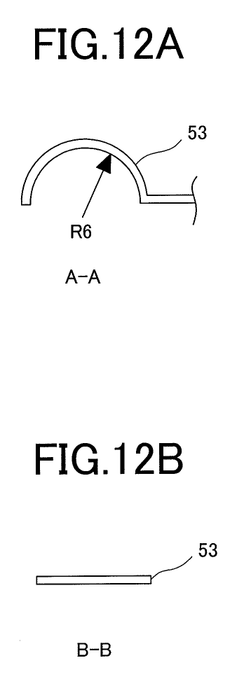

FIG. 11 is another example of the contact spring 50. This is the same as the contact spring 50 in FIG. 8, except the contact portion 53 of the contact spring 50. FIGS. 12A, 12B show the detail of the contact portion 53 of the contact spring 50 in FIG. 11. FIG. 12A is an A-A cross-sectional view of FIG. 11, and FIG. 12B is a B-B cross-sectional view of FIG. 11. In FIGS. 12A, 12B, the contact portion 53 of the contact spring 50 has the curvature radius R6 in the length direction of the contact spring 50, but is flat in the width direction of the contact spring 50. This shape allows smooth contact and sliding of the contact spring 50 when contacting the metal back 23. In addition, since the contact portion 53 is made flat in the width direction of the contact spring 50, it is possible to ensure a sufficient contact area with the metal back 23. In the embodiment, for example, the curvature radius R6 is 2 mm, but is preferably 5 mm or less.

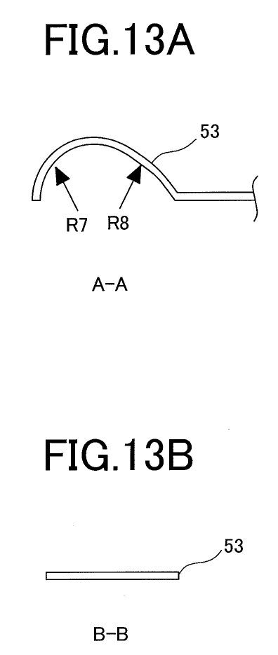

FIGS. 13A, 13B show still another example of the contact portion 53 of the contact spring 50 in FIG. 11. FIG. 13A is an A-A cross-sectional view of FIG. 11, and FIG. 13B is a B-B cross-sectional view of FIG. 11. In FIGS. 13A, 13B, the curvature radius of the contact portion 53 of the contact spring 50 is different in the end portion and in the root portion with respect to the length direction of the contract spring 50. The curvature radius R7 of the end portion is smaller than the curvature radius R8 of the root portion. This shape allows more smooth contact and sliding of the contact spring 50 when contacting the metal back 23. In addition, since the contact portion 53 is made flat in the width direction of the contact spring 50, it is possible to ensure a sufficient contact area with the metal back 23.

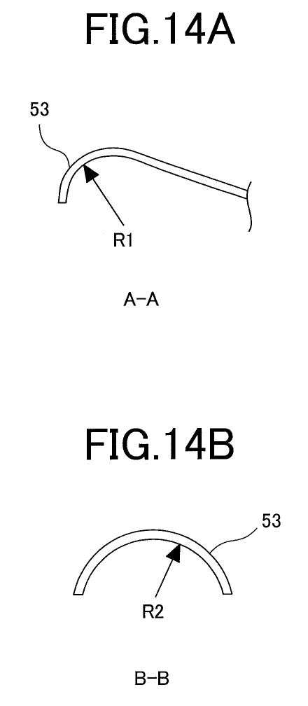

The contact springs 50 shown in FIGS. 9A, 9B, FIGS. 10A, 10B, FIGS. 12A, 12B, and FIGS. 13A, 13B each have a folding point between the arm portion 52 and the contact portion 53. However, the contact spring 50 according to this embodiment is not limited to such a shape. For example, it is needless to say that a shape, as shown in FIGS. 14A, 14B, defined by a smooth curve connecting the arm portion 52 and the contact portion 53 may also be used.

Incidentally, the position of the contact spring is not limited to the position of FIG. 1. In FIG. 1, the position of the contact spring is set in the vicinity of the exhaust hole 81, but is not necessarily near the exhaust hole 81. However, the corner portion is generally the most convenient place to set the contact spring.

### Second Embodiment

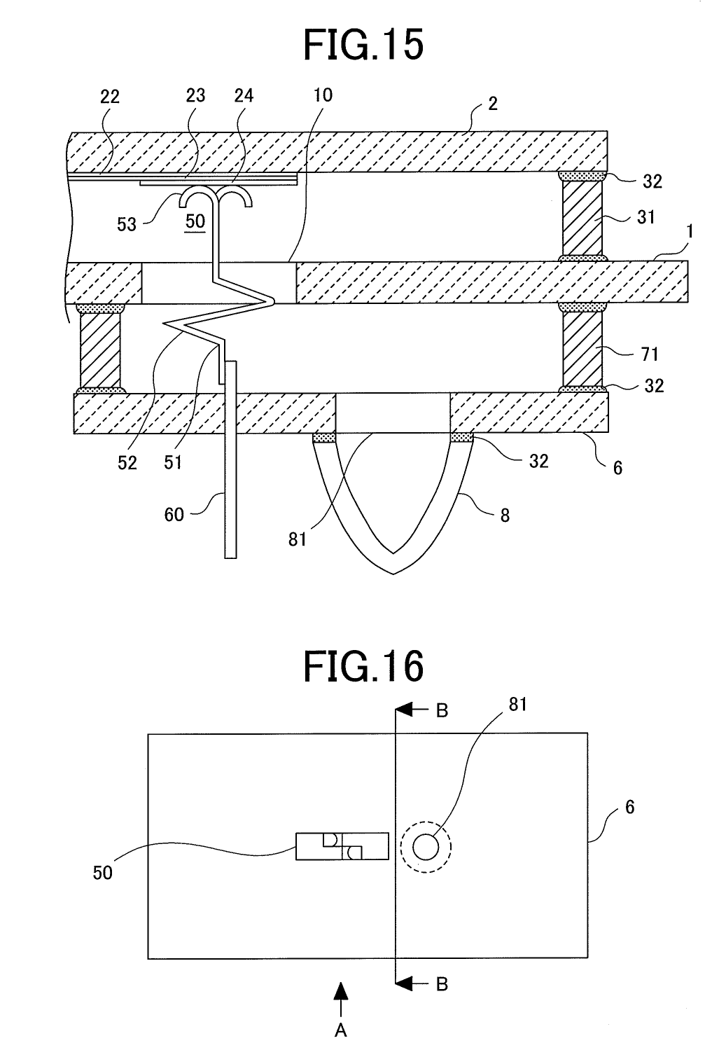

FIG. 15 shows a second embodiment of the present example. The configuration in FIG. 15 is the same as in FIG. 4 of the first embodiment, except the contact spring 50. In FIG. 15, the contact spring includes: the base portion 51 connected to the high voltage introduction terminal 60 by spot welding; the arm portion 52 for providing an appropriate contact pressure; and the contact portion 53 for contacting the anode substrate 24. The configuration of the metal back 23 is the same as the first embodiment.

Unlike the first embodiment, the arm portion 52 is a Z shape so that an appropriate contact pressure is provided to the contact spring 50. The Z-shaped portion is compressed in the vertical direction, and then the appropriate contact pressure is provided to the contact portion 53 of the contact spring 50. The feature of the second embodiment is that the contact spring 50 bends in a direction substantially orthogonal to the metal back 23, so that the contact portion 53 of the contact spring 50 hardly slides on the anode terminal or even slides a little. Since the contact spring 50 does not slide on the anode terminal, there is little possibility that the metal back 23 is shaved by the contact spring 50, or that the metal back 23 is scratched by the contact spring 50 when sliding on the anode terminal.

FIG. 16 is a plan view showing the state before the exhaust plate 6 according to the embodiment is attached to the cathode substrate 1. This is the same as the first embodiment in FIG. 5, except the shape of the contact spring 50 that is spot welded to the high voltage introduction terminal 60. In the embodiment, the contact portion 53 of the contact spring 50 is also divided into two parts so that the bending stress of the Z-shaped portion is evenly distributed.

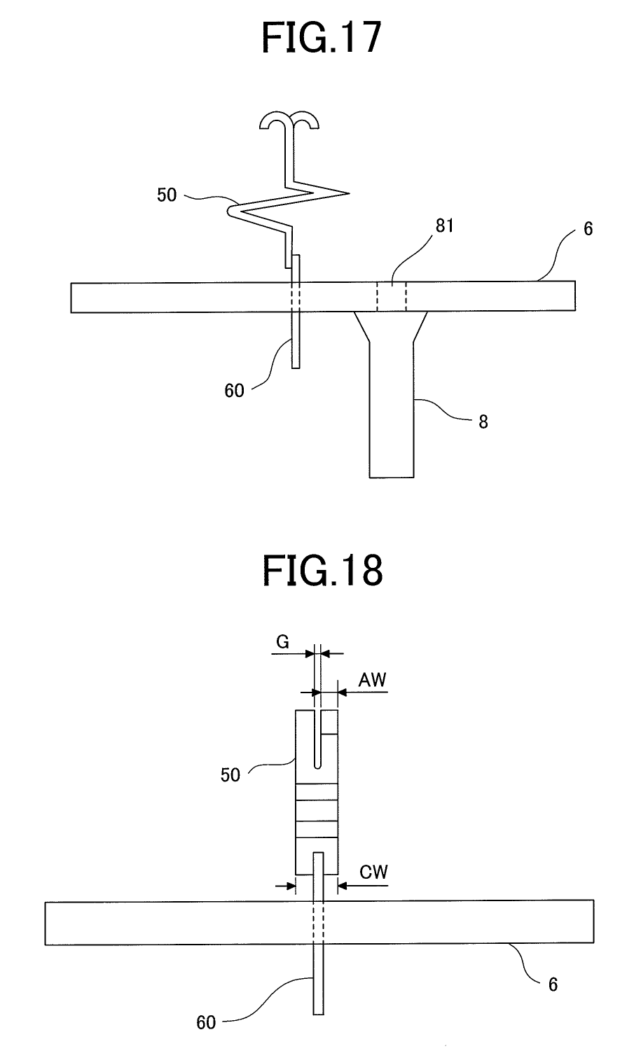

FIG. 17 is a side view seen from the A direction in FIG. 16. This is the same as the first embodiment in FIG. 6, expect the contact spring 50. FIG. 18 is a B-B cross-sectional view of FIG. 16. In FIG. 18, the contact pressure of the contact spring 50 is determined by the Z-shaped portion of the contact spring 50. However, it is also possible to share a part of the contact pressure by the arm portion that is divided into two parts and provided above the Z portion of the contact spring 50. In this case, a necessary contact pressure is obtained by the setting of the width and length of the arm portion 52. With this configuration, when an excessive contact pressure is given by the stress of only the Z portion, the pressure can be adjusted by bending the two divided parts of the arm portion. The FED display device has a limited space for the contact spring 50 and other components, so that this configuration may be necessary in certain applications.

In FIG. 18, the contact spring 50 is formed of Inconel in a similar way to the first embodiment. The width CW of the contact spring 50 is 5 mm, the width of each of the two divided parts of the arm portions is 2 mm, and the gap G between the two divided parts of the arm portion is 1 mm. The high voltage introduction terminal 60 is formed using an Fe—Ni alloy of φ1 mm in a similar way to the first embodiment. This is for matching the thermal expansion to that of the exhaust plate 6.

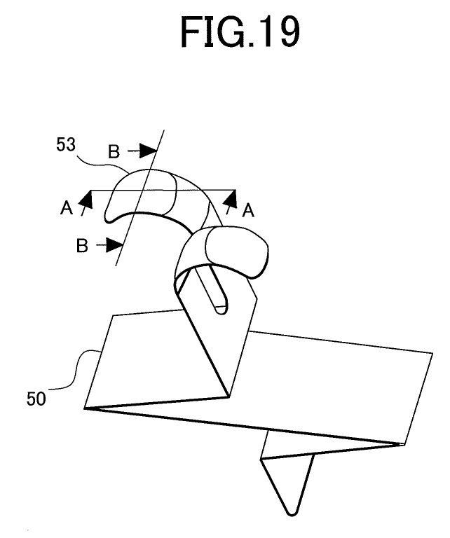

FIG. 19 shows the detailed shape of the contact spring 50 according to the embodiment. In FIG. 19, the contact portion 53 of the contact spring 50 is a sphere with a radius of 5 mm. Also in the embodiment, when the arm portion 52 of the contact spring 50 is long, the contact portion 53 of the contact spring 50 may slide on the anode terminal. In such a case, the curvature radius may be changed in the A-A cross section and in the B-B cross section as shown in FIG. 19. In this case, as shown in the first embodiment in FIGS. 9A, 9B, the curvature radius R1 in the length direction of the contact spring 50 can be smaller than the curvature radius R2 in the width direction of the contact spring 50. It is needless to say that, as shown in the first embodiment in FIGS. 10A, 10B, the curvature radius in the length direction of the contact spring 50 can be changed in the end portion and in the root portion.

Further, as shown in FIGS. 12A, 12B or FIGS. 13A, 13B, the B-B cross section in FIG. 19 may be made flat.

### Third Embodiment

FIG. 20 shows a third embodiment of the present example. The configuration in FIG. 20 is the same as the first embodiment of FIG. 4, except the contact spring 50. In the present embodiment, the contact spring 50 contacts the metal back 23, and slides on the anode terminal to obtain a predetermined contact pressure at a predetermined position. In the present embodiment, the distance at which the contact spring 50 slides on the anode terminal is larger than in the first and second embodiments. Thus, the shape of the contact portion 53 of the contact spring 50 is more important than in the other embodiments.

In the present embodiment, the contact pressure is determined by the bending stress of the arm portion 52 of the contact spring 50. The bending stress is proportional to the width of the contact spring 50, proportional to the amount of the bending, inversely proportional to the length of the contact spring 50, and proportional to the third power of the plate thickness of the contact spring 50. These properties further facilitate the control of the contact pressure. The bending stress of the contact spring 50 is dominated by the shape of the arm portion 52 near the base portion 51.

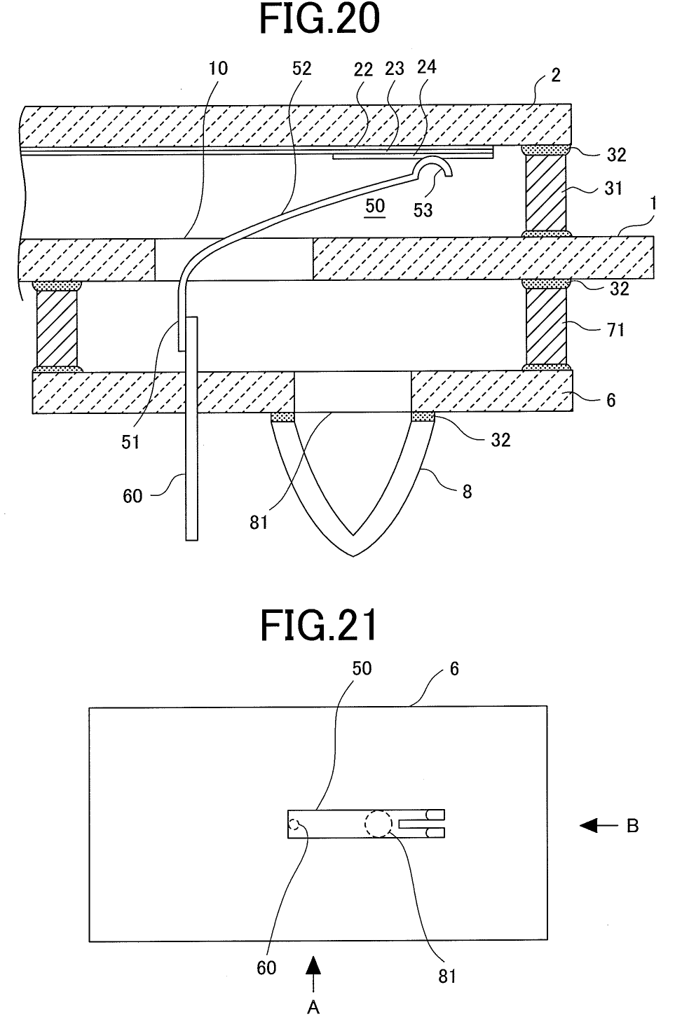

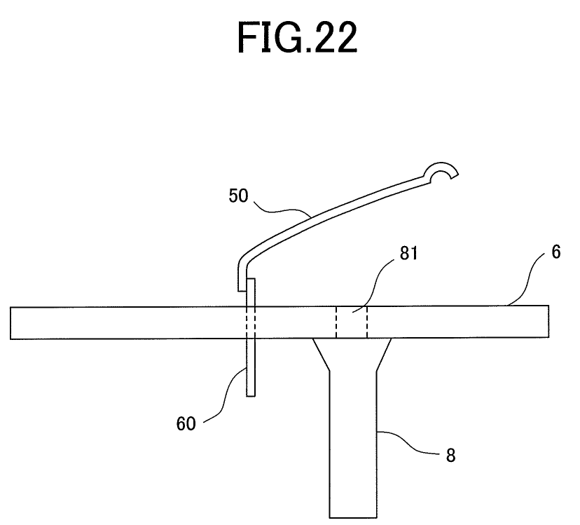

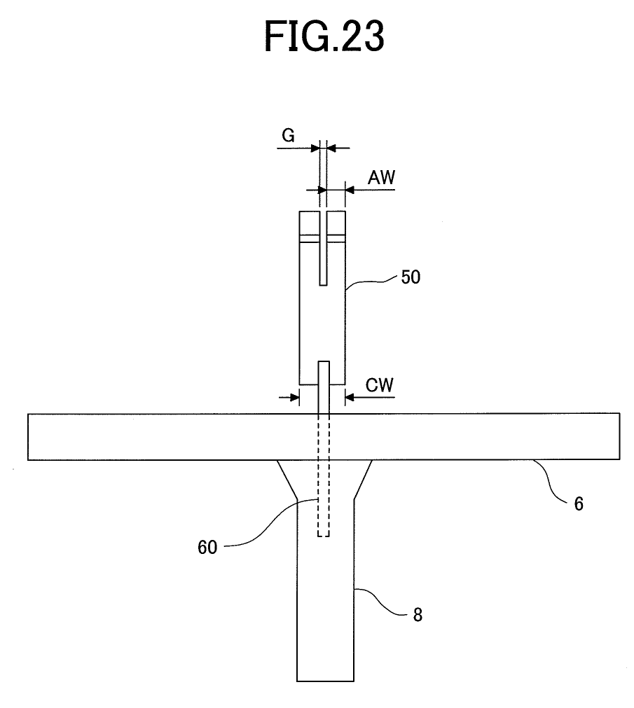

FIG. 21 is a plan view showing the state before the exhaust plate 6 is attached to the cathode substrate 1. This is the same as in the first embodiment in FIG. 5, except the contact spring 50. FIG. 22 is a side view seen from the A direction in FIG. 21. Similarly, the configuration in FIG. 22 is the same as in the first embodiment in FIG. 6, except the contact spring 50. FIG. 23 is a side view seen from the B direction in FIG. 21. In FIG. 23, the contact spring 50 is divided into two parts near the end portion. The width CW of the contact spring 50 is 5 mm, the width AW of each of the two divided parts of the arm portion is 2 mm, and the gap G between the two divided parts of the arm portion is 1 mm. The material of the contact spring 50 is Inconel having a thickness of 0.1 mm.

As shown in FIG. 20, when the contact spring 50 bends in the vicinity of the base portion 51 of the contact spring 50, the bending stress is dominated by the shape of the root portion. While when the contact spring 50 mainly bends in the arm portion which is divided into two parts, the bending stress is determined by the width, length or other dimensions of each of the upper parts.

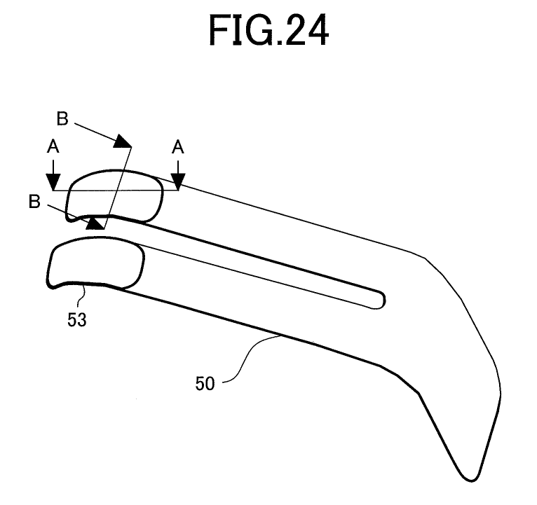

FIG. 24 shows the detailed shape of the contact spring 50 in the present embodiment. The contact portion 53 of the contact spring 50 can take the shapes shown in FIGS. 9A to 14B.

### Forth Embodiment

FIG. 25 is a schematic cross-sectional view showing a forth embodiment the present example. In FIG. 25, the high voltage introduction terminal 60 is formed passing through the cathode substrate 1 while maintaining air tightness against the outside. In the present embodiment, the exhaust tube 8 is also attached to the cathode substrate 1 directly by the frit glass, and not through the exhaust plate 6. FIG. 25 shows the state in which the exhaust tube 8 is chipped off.

In the present embodiment, the configuration is the same as described in the third embodiment in FIG. 20, except that the exhaust tube 8 is attached to the cathode substrate 1 and not to the exhaust plate 6. In the present embodiment, the high voltage introduction terminal 60 is attached to the cathode substrate 1 in advance. Thus, it is necessary to pay attention to the handling of the cathode substrate 1. Meanwhile, it is possible to omit the process of sealing the exhaust plate 6.

In FIG. 25, the contact spring 50 is the same type as used in the third embodiment. However, it is needless to say that the contact spring 50 of the types used in the first and second embodiments can also be used. The present embodiment is different from the first to third embodiments in that the distance from the high voltage introduction terminal 60 to the metal back 23, is smaller than in the other embodiments. Thus, it is necessary to ensure that the contact pressure of the contact spring 50 is not excessively increased.

With the configuration of the embodiment, there is no need to provide the high voltage introduction terminal 60 in the exhaust plate 6. Thus, the degree of freedom with respect to the setting position of the high voltage introduction terminal 60 is increased. For example, the metal back 23 can be arranged diagonally to the exhaust tube 8. In such a case, it is also possible that the exhaust tube 8 is provided in the exhaust plate 6 while the high voltage introduction terminal 60 is directly provided in the cathode substrate 1.

### Second Example

### First Embodiment

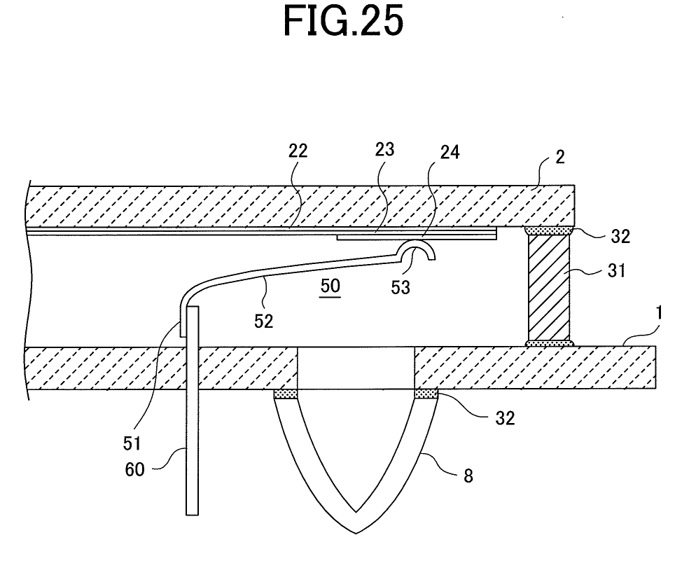

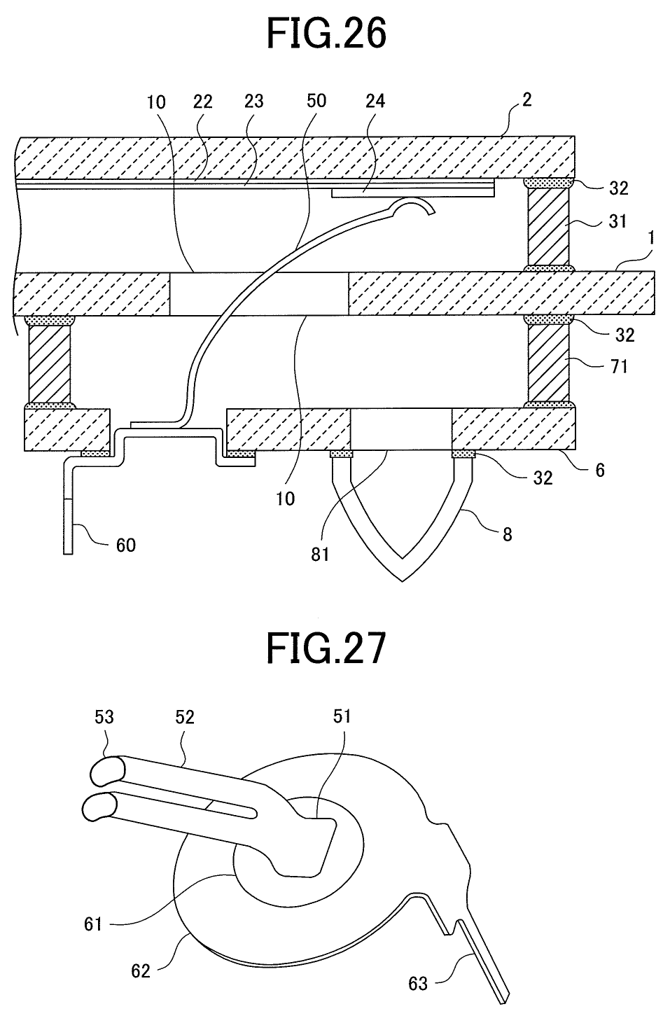

FIG. 26 is a B-B cross-sectional view of FIG. 1, which shows a substantial portion of a first embodiment. In FIG. 26, the through hole 10 is formed in the cathode substrate 1. The evacuation of the display device, or the high voltage supply is performed through the through hole 10. The exhaust plate 6 is provided covering the through hole 10 of the cathode substrate 1 through the exhaust plate sealing portion 7. In this way, the interior of the display device is maintained at a vacuum. The basic configuration of the exhaust plate sealing portion 7 is the same as that of the sealing portion 3 for sealing the cathode substrate 1 and the anode substrate 2. In other words, the exhaust plate frame 71 is sealed to the cathode substrate 1 and to the anode substrate 2 through the sealing 32. In the present embodiment, the thickness of the frame 31 for sealing the anode substrate 2 and the cathode substrate 1, and the thickness of the frame for sealing the cathode substrate 1 and the exhaust plate 6, are set to the same value. However, the thickness of the frames can be freely set according to the necessity.

The high voltage introduction button 60 is attached to the cathode substrate by the sealing 32 to maintain air tightness against the outside. The frit glass is used for the sealing 32. While the Fe—Ni alloy is used for the high voltage introduction button. The composition ratio of the Fe—Ni alloy is selected so that the thermal expansion coefficient is matched to that of the sealing 32. The contact spring 50 is spot welded to the high voltage introduction button 60. The contact spring is formed of Inconel which can easily be spot welded to the Fe—Ni alloy.

The contact spring 50 includes the base portion 51 connected to the high voltage introduction button 60, the arm portion 52, and the contact portion 53. Upon bending of the arm portion 52 of the contact spring 50, a bending stress is applied to the contact portion 53 of the contact spring 50. Then the contact portion 53 contacts the metal back 23 formed in the anode substrate 2 with an appropriate force. In the present embodiment, the contact pressure of the contact spring is about 10 g. The contact portion 53 of the contact spring 50 is an appropriate curve, such as a sphere, and is able to stably contact the metal back 23. Taking into account the heat resistance or other relevant characteristics, Inconel having a thickness of 0.1 mm is used as the material of the contact spring 50.

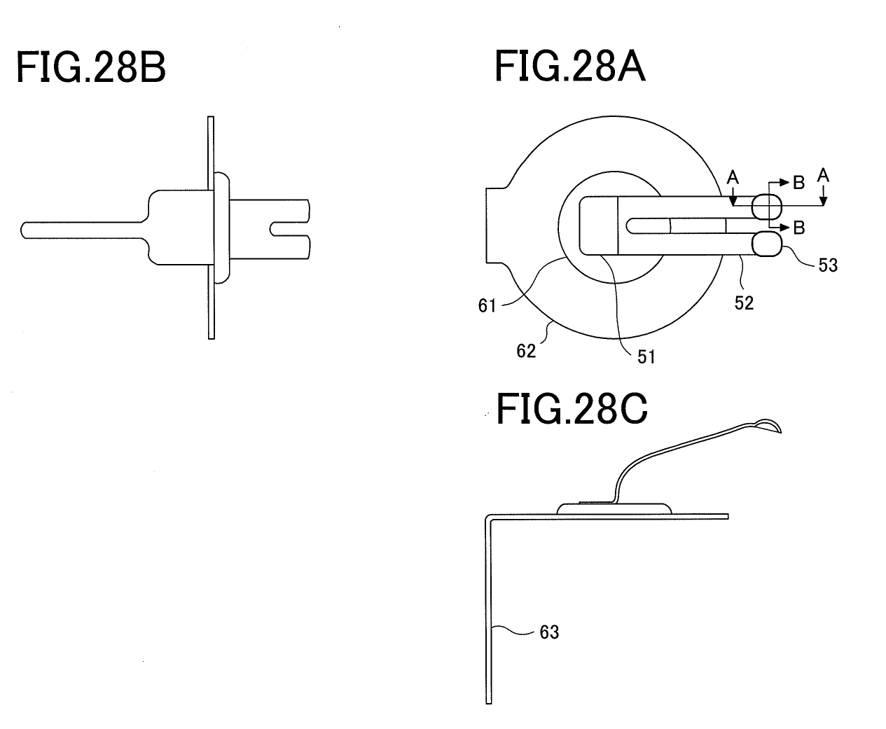

FIG. 27 is a perspective view showing the state in which the high voltage introduction button 60 and the contact spring 50 are connected by spot welding. In FIG. 27, the high voltage introduction button 60 includes: a flat portion 61 to which the contact spring 50 is spot welded; a sealing portion 62 sealed to the exhaust plate 6 by the sealing 32; and an external terminal 63 to be connected to an external power source. FIG. 28A is a plan view showing the state in which the high voltage introduction button 60 and the contact spring 50 are spot welded. FIG. 28B is a side view, and FIG. 28C is another side view. As shown in FIG. 28C, unlike the other portions, the contact portion 53 of the contact spring 50, which contacts the anode terminal 24, is formed as a curve having a small curvature radius. This is for ensuring a stable connection with the anode terminal 24 formed in the anode substrate 2. The arm portion 52 of the contact spring 50 is divided into two parts. This helps to increase the reliability of the contact with the anode terminal 24.

The contact portion 53 of the contact spring 50 for contacting the anode terminal 24 can take various shapes as shown in the first embodiment in FIGS. 9A to 14B.

### Second Embodiment

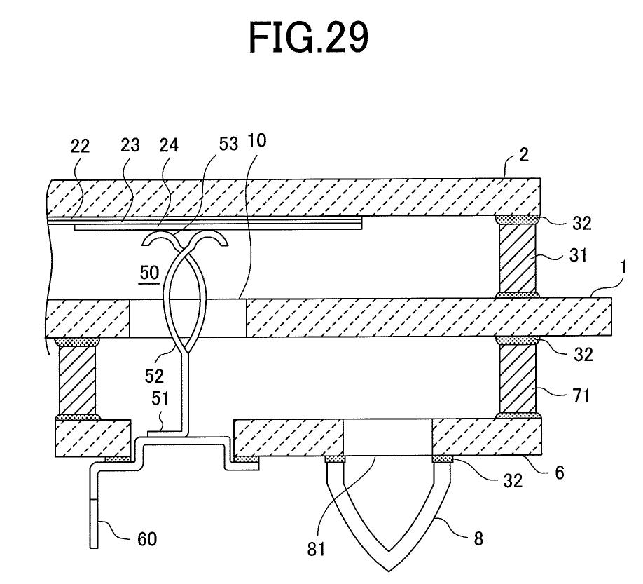

FIG. 29 shows a second embodiment of the present example. The configuration in FIG. 29 is the same in the first embodiment in FIG. 26, except the contact spring 50. In FIG. 29, the contact spring 50 includes: the base portion 51 connected to the high voltage introduction button 60 by spot welding; the arm portion 52 for providing an appropriate contact pressure to the contact spring 50; and the contact portion 53 for contacting the anode terminal 24. The configuration of the metal back 23 is the same as the first embodiment.

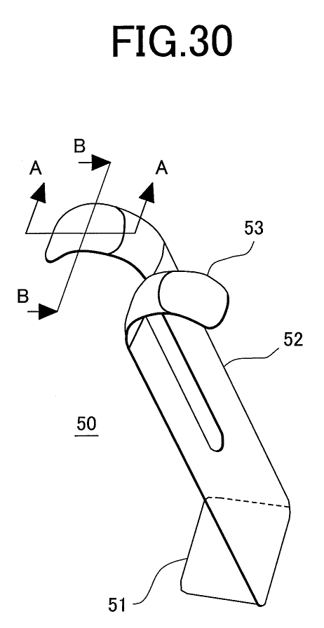

FIG. 30 is a perspective view of the contact spring 50 used in the present embodiment. The width of the contact spring 50 is 5 mm. The arm portion 52 is divided into two parts. Each part of the arm portion 52 is designed to bend in an opposite direction when the contact spring 50 contacts the anode substrate 2. The width of each part of the arm portion is 2 mm, the gap between the two divided parts is 1 mm, and the arm length is about 10 mm. The material of the contact spring 50 is Inconel having a thickness of 0.1 mm. In the present embodiment, the contact pressure due to the bending of the arm portion 52 when the contact spring 50 contacts the anode substrate 2 is about 10 g.

The contact portion 53 of the contact spring 50 can take various shapes as shown in FIGS. 9A to 14B.

### Third Embodiment

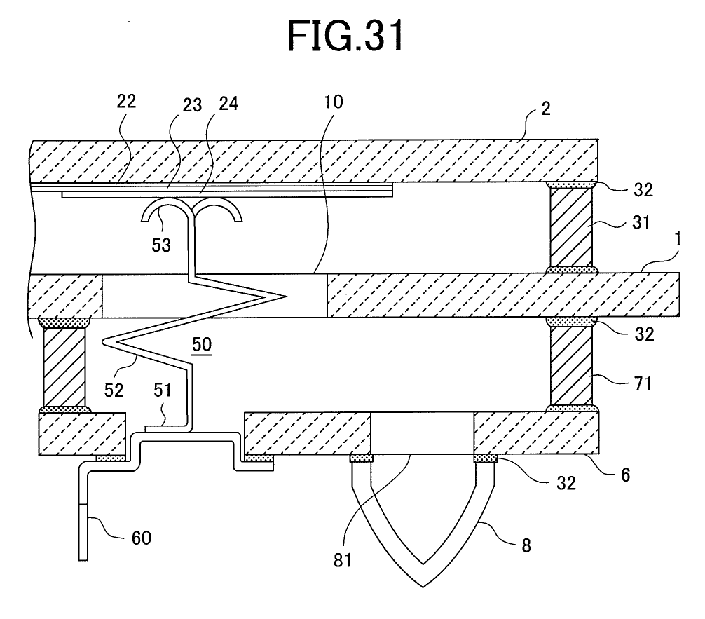

FIG. 31 shows a third embodiment of the present example. The configuration in FIG. 31 is the same as in the first embodiment in FIG. 26, except the contact spring 50. In FIG. 31, the contact spring 50 includes: the base portion 51 connected to the high voltage introduction button 60 by spot welding; the arm portion 52 for providing an appropriate contact pressure to the contact spring 50; and the contact portion 53 for contacting the anode terminal 24. The configuration of the metal back 23 is the same as the first embodiment.

Unlike the first embodiment, the arm portion 52 is a Z shape so that an appropriate contact pressure is provided to the contact spring 50. The Z-shaped portion is compressed in the vertical direction, and then an appropriate contact pressure is provided to the contact portion 53 of the contact spring 50. The feature of the third embodiment is that the contact spring 50 bends in a direction substantially orthogonal to the metal back 23, so that the contact portion 53 of the contact spring 50 hardly slides on the anode terminal or slides only a little. Since the contact spring 50 does not slide on the anode terminal, there is little possibility that the metal back 23 is shaved by the contact spring 50, or that the metal back 23 is scratched by the contact spring 50 when sliding on the anode terminal.

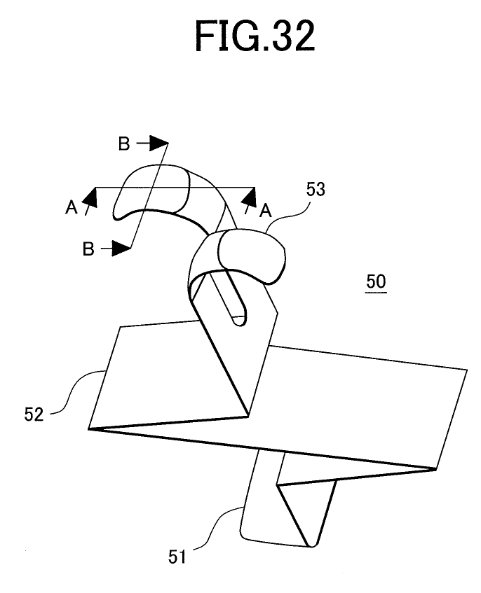

FIG. 32 is a perspective view of the contact spring 50 used in the present embodiment. Also in the embodiment, the contact portion 53 of the contact spring 50 is divided into two parts so that the bending stress of the Z-shaped portion is evenly distributed. In FIG. 32, the contact spring 50 is formed of Inconel having a thickness of 0.1 mm, in a similar way to the first embodiment. The width of the contact spring 50 is 5 mm, the width of each of the two divided parts of the arm portion is 2 mm, and the gap between the two divided parts of the arm portion is 1 mm. The high voltage introduction button 60 is formed of an Fe—Ni alloy, in a similar way to the first embodiment.

In FIG. 32, the contact portion 53 of the contact spring 50 can take various shapes as shown in FIGS. 9A to 14B.

### Fourth Embodiment

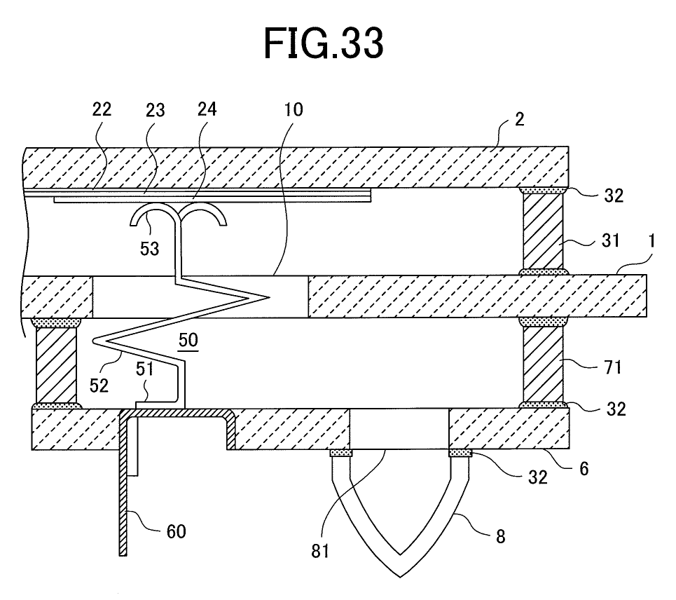

FIG. 33 is a cross-sectional view showing a fourth embodiment of the present example. In the first to third embodiments, the high voltage introduction button 60 is sealed to the exhaust plate 6 through the frit glass 32 which is the sealing. In the present embodiment, the high voltage introduction button 60 is directly fused to the exhaust plate 6 and not through the frit glass, which is largely different from the first to third embodiments. The frit glass is convenient as the sealing 32 for glass and the like, but has less withstand voltage characteristics than that of the normal glass. The high voltage introduction button 60 is applied with a high voltage of 8 KV to 10 KV, and there may be a problem with the withstand voltage characteristics when the frit glass is used. The present embodiment does not use the frit glass and is able to realize a display device having excellent withstand voltage characteristics.

The process of sealing the high voltage introduction button 60 to the exhaust plate 6 is summarized as follows. That is, the exhaust plate 6 is formed by melting the glass material in a specific mold. The high voltage button 60 with a predetermined shape is placed in the mold in advance. The glass is melted as the temperature increases. At this time, the melted glass wets the outside of the high voltage introduction button 60. When the glass is cooled and solidified, the high voltage introduction button 60 is fixed to the glass while maintaining air tightness.

The glass is cracked during the cooling down, unless the thermal expansion coefficient of the exhaust plate 6 and the thermal expansion of the high voltage introduction button 60 are equal to each other. In the present embodiment, the high voltage introduction button 60 is formed of an Fe—Ni alloy. The content of Ni is adjusted to 48% so that the thermal expansion coefficient is matched to that of the exhaust plate 6. Incidentally, the thermal expansion coefficient of the glass substrate varies depending on the composition of the glass. In the case of using the Fe—Ni alloy, it is possible to change the thermal expansion coefficient by adjusting the content of Ni. Another advantage is that, as shown in FIG. 33, the high voltage introduction button 60 of Fe—Ni alloy can easily be spot welded to the contact spring 50 of Inconel.

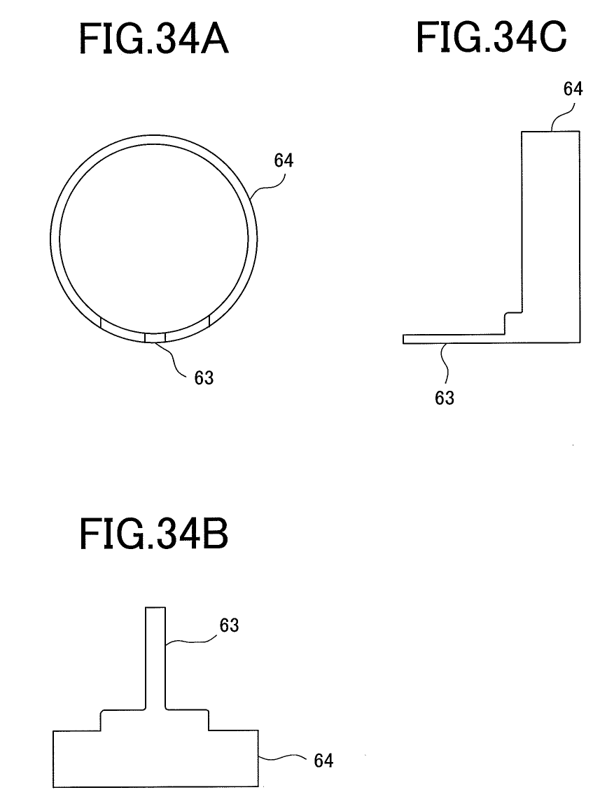

FIGS. 34A to 34C show the shape of the high voltage introduction button 60 used in the present embodiment. FIG. 34A is a plan view of the high voltage introduction button 60, FIG. 34B is a side view, and FIG. 34C is another side view. At the time when the high voltage introduction button 60 is embedded into the substrate, a side surface of a button portion 64 is sealed to the substrate. As shown in FIGS. 34A to 34C, the high voltage introduction button 60 includes the button portion 64 having an approximately cylindrical shape, and the external terminal 63 to be connected to the external power source. The plate thickness is 0.5 mm. In the embodiment, the Fe—Ni alloy is used as the material of the high voltage introduction button 60. However, it is needless to say that other metals or alloys can also be used, as long as they are wettable with glass and meet conditions such as heat resistance and thermal expansion coefficient.

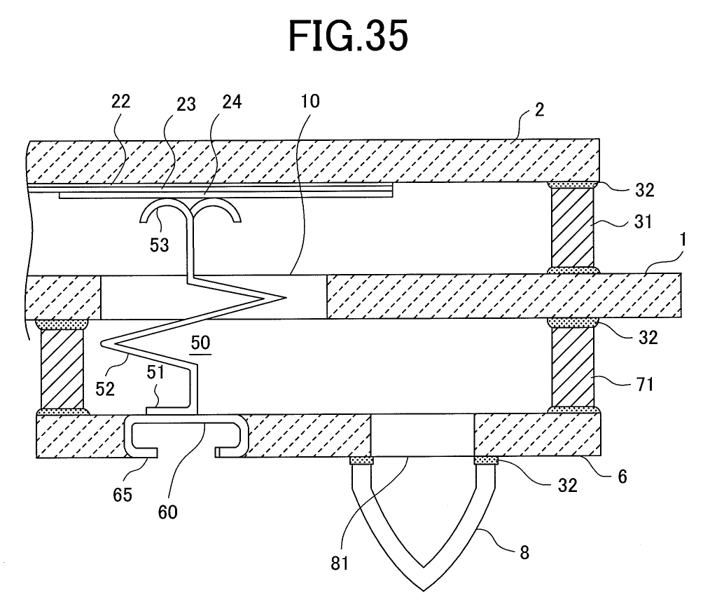

In FIGS. 34A to 34C, since the high voltage introduction button 60 has the external terminal 63 projected outward as shown in FIG. 33, there may be a problem in the handling of the substrate. In other words, the external terminal 63 may hinder in the processes such as production and storage. FIG. 35 is a cross-sectional view showing another configuration of the present embodiment. In FIG. 35, the high voltage introduction button 60 has no external terminal 63. Thus, the handling of the exhaust plate 6 is easy. In addition, the handling of the display device after the exhaust plate 6 is attached to the cathode substrate 1 is also facilitated by eliminating the external terminal 63 from the high voltage introduction button 60.

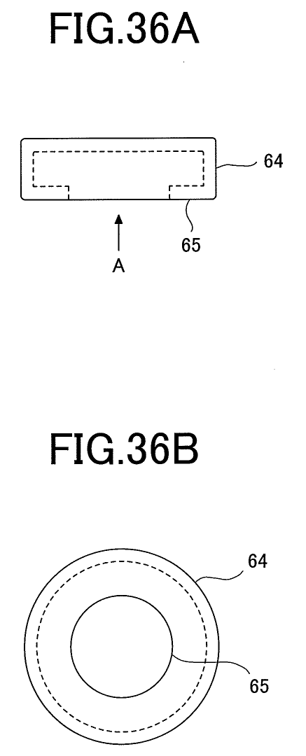

FIGS. 36A, 36B are views showing the shape of the high voltage introduction button 60 used in FIG. 35. FIG. 36A is a side view of the high voltage introduction button 60, and FIG. 36B is a plan view. The side surface shown in FIG. 36A will be sealed to the substrate. The high voltage introduction button 60 of FIGS. 36A, 36B has a cylindrical shape with an approximately closed bottom, in which an opening having a flange 65 is formed. When a high voltage is supplied from the outside, a terminal abuts against the flange 65 and fixed from the outside. In FIGS. 36A, 36B, the high voltage introduction button 60 is formed of the Fe—Ni alloy having a thickness of 0.5 mm, in a similar way to the high voltage introduction button 60 shown in FIGS. 34A to 34C.

The contact spring 50 shown in FIGS. 33 and 35 is the same as that used in the third embodiment. However, it is needless to say that the present embodiment can be applied in the same manner as in the case of the contact springs 50 used in the first and second embodiments. The use of the high voltage introduction button 60 as shown in FIG. 36 further facilitates the handling of the exhaust plate 6, the handling of the cathode substrate 1 after attachment of the exhaust plate 6, and the handling of the display device. As a result, the productivity can be increased.

### Fifth Embodiment

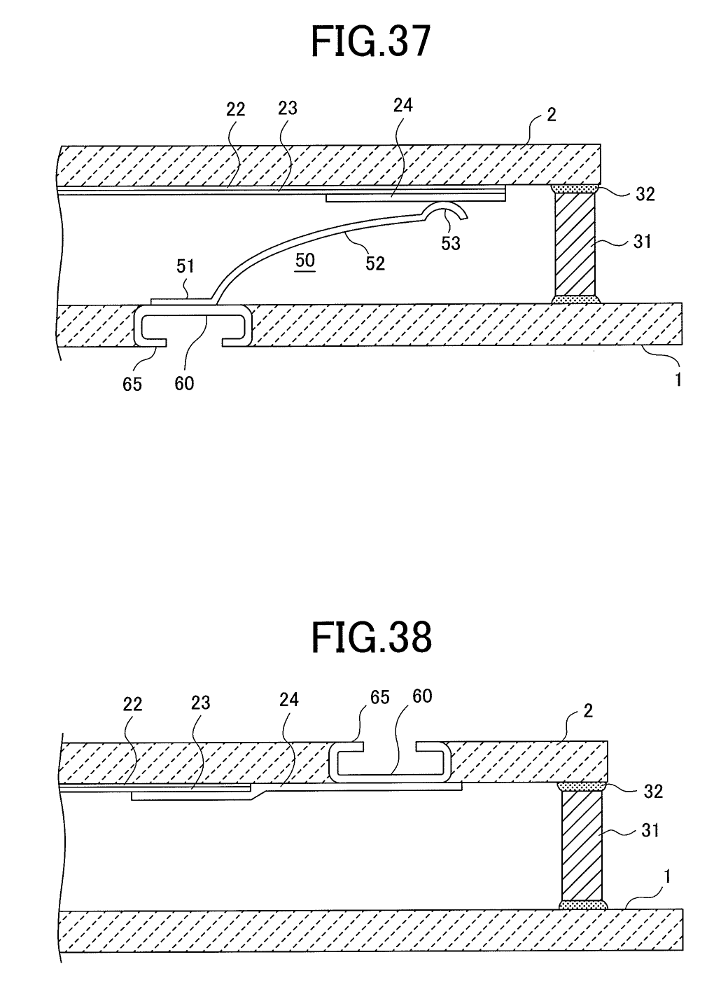

FIG. 37 shows a fifth embodiment of the present example. The high voltage introduction button 60 is attached to the exhaust plate 6 in the first and fourth embodiments. In the fifth embodiment, the high voltage introduction button 60 is directly attached to the cathode substrate 1, and not to the exhaust plate 6. The high voltage introduction button 60 used in the present embodiment is the hollow circular cylinder with a flange as shown in FIG. 18. The method of embedding the high voltage introduction button 60 into the cathode substrate 1 is the same as described in the fourth embodiment.

In the present embodiment, the high voltage introduction button 60 can be provided on the same surface of the cathode substrate 1 or more inside than the surface of the cathode substrate 1. Thus, although the high voltage introduction button 60 is formed in the cathode substrate 1 in advance, the high voltage introduction button 60 will not hinder in the production process. Another advantage is that because there is no need to attach the high voltage introduction button 60 to the exhaust plate 6, the high voltage introduction portion can be attached to any place in the display device according to the design, for example, without regard for the position of the exhaust hole 81.

The contact spring 50 used in FIG. 37 is the same as that in the first embodiment. However, it is needless to say that the contact spring 50 is not limited thereto, and the contact spring 50 used in the second or third embodiment can also be used.

### Sixth Embodiment

In the first to fifth embodiments, the high voltage introduction button 60 is attached to the cathode substrate side, namely, attached to the exhaust plate 6 or to the cathode substrate 1. The high voltage introduction button 60 is connected to the anode terminal 24 on the anode substrate side by the contact spring 50. In other words, it is necessary to have a mechanism for connecting the cathode substrate side and the anode substrate side. FIG. 38 shows a sixth embodiment of the present example, in which the high voltage introduction button 60 is provided on the anode substrate side. This configuration has an advantage that the mechanism for connecting the cathode substrate side and the anode substrate side can be omitted.

The high voltage introduction button 60 used in FIG. 38 is the same as shown in FIGS. 36A, 36B. In the embodiment shown in FIG. 38, the high voltage introduction button 60 can be provided in the same surface as the anode substrate, or more inside than the surface of the anode substrate 2. With this configuration, although the high voltage introduction button 60 is formed in the anode substrate 2 in advance, the high voltage introduction button 60 will not hinder in the production process. In addition, there is no need to attach the high voltage introduction button 60 to the exhaust plate 6, and no need to leave space for attaching the contact spring 50 and other components. Thus, the degree of freedom in the design of the high voltage introducing portion is increased compared to the first to fifth embodiments.

In the present embodiment, the high voltage introduction button 60 is provided in the periphery of the anode substrate 2 and outside the effective screen. The high voltage introduction button 60 and the inner surface of the anode substrate 2 are not perfectly flat, but form roughness. As a result, conduction failure may occur due to step disconnection on the surface only covered with the BM 22 or the thin film such as the metal back 23. In the embodiment, as shown in FIG. 20, a relatively thick conductive film is formed on the high voltage introduction button or in the periphery thereof. Thus, the high voltage is supplied to the metal back 23 and the like through this conductive film. As described in the first embodiment, the conductive film is formed by applying a paste in which metal particles are dispersed in an organic solvent with high viscosity, followed by baking. The film thickness of the conductive film after baking is 10 μm to 30 μm. As described in the first embodiment, particles of Ag, Ni, Al or other metal are used as the metal particles. The resistance of the conductive film can be increased, as described in the first embodiment, by mixing the frit glass and the like with the metal paste. Another example of the material used for the conductive film is black lead mixed with a binder. In this case, the black lead is preferably graphite because of its high conductivity. The electrical resistance of the conductive film can be increased by mixing an insulating material such as colcothar (iron oxide) frit glass with a black lead paste, followed by baking and then forming the film.

In FIG. 38, the BM 22 and the metal back 23 are connected to the high voltage introduction button 60 by the conductive film. However, the BM 22 or the metal back 23 may be extended to the high voltage introduction button 60. The high voltage introduction button 60 has been embedded into the anode substrate 2 in the state of the anode substrate 2 in which the phosphor 21, BM 22, metal back 23 and the like are not formed. Thus, the amount of extension of the BM 22 or the metal back 23 can be determined in a relatively flexible manner according to the design requirements.

Because the surface of the anode substrate 2 is likely to be rough in the vicinity in which the high voltage introduction button 60 is embedded. Thus, when the BM 22 or the metal back 23 is extended to the high voltage introduction button 60, it is also preferred to apply the above described conductive film over the high voltage introduction button 60 in order to prevent the conduction failure due to step disconnection. Even in the case in which the BM 22 or the metal back 23 is not extended to the high voltage introduction button, it is possible to reliably prevent the conduction failure due to step disconnection, by applying twice the conductive film containing the metal particles or black lead as described above.

As described above, according to the present embodiment, because the high voltage introduction button 60 is provided in the anode substrate 2, there is no need to have a mechanism for connecting the cathode substrate side and the anode substrate side, such as the contact spring 50. As a result, the production cost can be significantly reduced. Further, the high voltage introduction button 60 and the metal back 23 and the like can be connected by applying the conductive film containing metal particles or graphite and the like, so that the reliability is also improved.

### Third Example

### First Embodiment

FIG. 27 is a perspective view showing the state in which the contact spring 50 is spot welded to the high voltage introduction terminal 60. In FIG. 27, an upper surface of the sealing portion 62 of the high voltage introduction terminal 60 is sealed to the exhaust plate 6 through the frit glass. The projection 63 to be connected to an external socket is formed in the high voltage introduction terminal 60.

The contact spring 50 is formed of Inconel which can easily be spot welded to the Fe—Ni alloy. The contact spring includes the base portion 51 connected to the high voltage introduction terminal 60, the arm portion 52, and the contact portion 53. Upon bending of the arm portion 52 of the contact spring 50, a bending stress is applied to the contact portion 53 of the contact spring 50. Then the contact portion 53 contacts the metal back 23 formed in the anode substrate 2 with an appropriate force. In the present embodiment, the contact pressure of the contact spring 50 is about 10 g, which may be larger than 10 g due to irregularity of parts. The contact portion 53 of the contact spring 50 is an appropriate curve, such as a sphere, and is able to stably contact the anode terminal 24. Taking into account the heat resistance or other relevant characteristics, Inconel having a thickness of 0.1 mm is used as the material of the contact spring 50.

One advantage of the high voltage introduction terminal 60 attached to the exhaust plate 6 as shown in FIG. 26, is that the process of sealing the high voltage introduction terminal 60 can be streamlined, because the high voltage introduction terminal 60 is sealed to the relatively small exhaust plate 6. In other words, the exhaust plate 6 is much smaller than the cathode substrate or other substrate, so that it is possible to seal a large number of high voltage introduction terminals 60 at a time. Further, in the case of sealing the high voltage introduction terminal 60 to the cathode substrate or other substrate, there is a problem that the expensive and large substrate should be destroyed when a sealing failure occurs in the high voltage introduction terminal 60. To cope with this problem, the high voltage introduction terminal 60 is sealed to the exhaust plate 6. In this case, only the exhaust plate 6 is failed when a sealing failure occurs in the high voltage introduction terminal 60, so that the damage can be reduced to a minimum.

The anode terminal 24 is formed in the anode substrate 2 to contact the contact spring 50. Because a large current flows through the anode terminal 24, its reliability is important. Also, the anode terminal 24 should be mechanically strong enough for the pressure applied by the contact spring 50. Further, because a large current flows between the contact spring 50 and the anode terminal 24, the anode terminal 24 should have an electrical resistance small enough so as not to generate large heat. Still further, the anode terminal 24 should have a heat resistance structure in case of heat generation.

FIG. 39 is a schematic plan view of the vicinity of the anode substrate 2 in which the anode terminal 24 is formed. In FIG. 39, the sealing portion 3 is formed around the anode substrate 2. In a display area 100, the phosphors 21 are formed corresponding to a large number of pixels for forming an image. The black matrix 22 and the metal back 23 are formed in an area larger than the display area 100. The black matrix 22 and the metal back 23 are formed in the same area, so that only the metal back 23 is shown in FIG. 39. The black matrix 22 and the metal back 23 extend about the sealing portion 3 in a corner portion. The anode terminal 24 is formed on the metal back 23 in the corner portion.

In the present embodiment, the configuration in the vicinity of the anode terminal 24 is as follows. That is, the conductive film is formed to have a thickness of 5 μm to 30 μm, as the anode terminal 24 on the metal back 23. In FIG. 39, the shape of the anode terminal 24 is a circle with a diameter of 20 mm or less, preferably 10 mm or less. In the embodiment, the silver paste is applied by printing, followed by baking to form the conductive film. There is no need to provide a specific process for baking the conductive film. It can be simultaneously done, for example, in the baking process for fixing the spacer 4.

The silver paste used in the embodiment is not the normal silver paste, which is prepared by dispersing silver particles and silver flakes in the frit glass. Traditionally the lead based frit glass has been used, but non-lead frit glass is used in the embodiment in order to take into account the environmental impact. More specifically, a vanadium based frit glass is used in the embodiment. The vanadium based frit glass (hereinafter referred to as V frit) is roughly divided into two types: one is insulating and the other is conductive. The composition of the insulating V frit is, for example, V₂O₅: 50%, P₂O₅: 10%, BaO: 20%, WO₃: 15%, TeO₂: 15%+balance. While the composition of the conductive V frit is, for example, V₂O₅: 50% to 60%, P₂O₅: 25%, BaO: 5%, Sb203: balance. These are the compositions of the V frit after baking, excluding the silver particles or silver flakes. Both the insulating V frit and the conductive V frit contain vanadium oxide as the main component. Upon application, the V frit is in a paste state with the silver particles or silver flakes dispersed therein, in which the above described components are dispersed in vehicles. The vehicles fly apart and disappear during the baking process after application.

The conventional silver paste is prepared by dispersing only the silver particles. However, the sliver paste used in the embodiment is prepared by dispersing silver particles or silver flakes in the V frit. According to the experiments conducted by the inventors, it is difficult to sufficiently reduce the resistance with the conventional silver paste containing only the silver particles. In the case of using the V frit as in the embodiment, particularly the resistance value is important. In other words, the main component of the V frit is the oxide such as V₂O₅. When such an oxide is formed on the metal back 23 of Al, Al is oxidized to produce alumina Al₂O₃ between the anode terminal 24 and the metal back 23. As a result, sufficient conductivity may not be obtained.

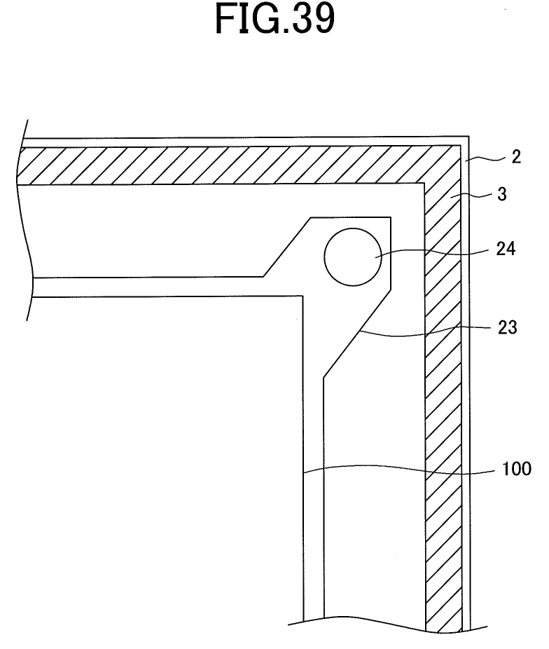

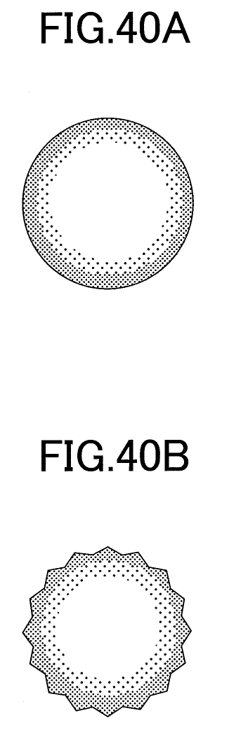

In the embodiment, the problem of the increase of the resistance value is solved by dispersing silver flakes, in addition to silver particles. In other words, although the alumina Al₂O₃ is produced between the anode terminal 24 and the metal back 23, edge portions of a silver flake destroy the thinly formed alumina Al₂O₃ to ensure conductivity. FIGS. 40A, 40B are examples of a silver particle used in the past. The diameter of the silver particle is 1 μm to several μm. FIG. 40A shows a circular particle, but actually the surface is not smooth. The circular particle often has a rough surface as shown in FIG. 40B.

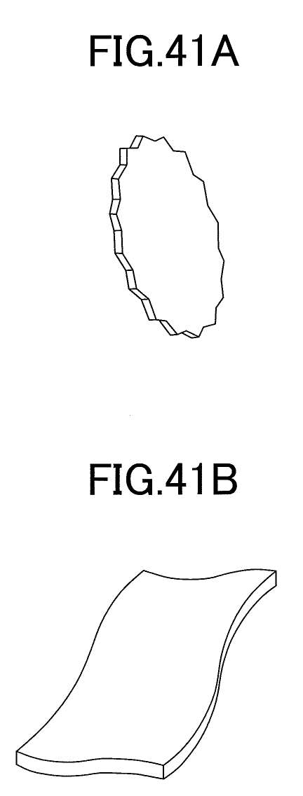

FIGS. 41A, 41B are examples of a flake-like silver particle. The silver flake can take various shapes. FIG. 41A is an example of a disk-like flake. FIG. 41B is an example of a plate-like flake. The shape of the silver flake is not limited and can be any suitable shape. Because the flake-like particles destroy the thin alumina Al₂O₃ produced between the metal back 23 and the anode terminal 24, the conduction failure can be avoided. The ratio of the silver flake to the silver particle is preferably 50% or more. Further, the content of the silver flake of 70%±10% is the most effective. Incidentally, the percent is by weight in this case. The content of silver in the anode terminal 24, namely the total content of the silver particles and silver flakes is 60% by weight to 95% by weight.

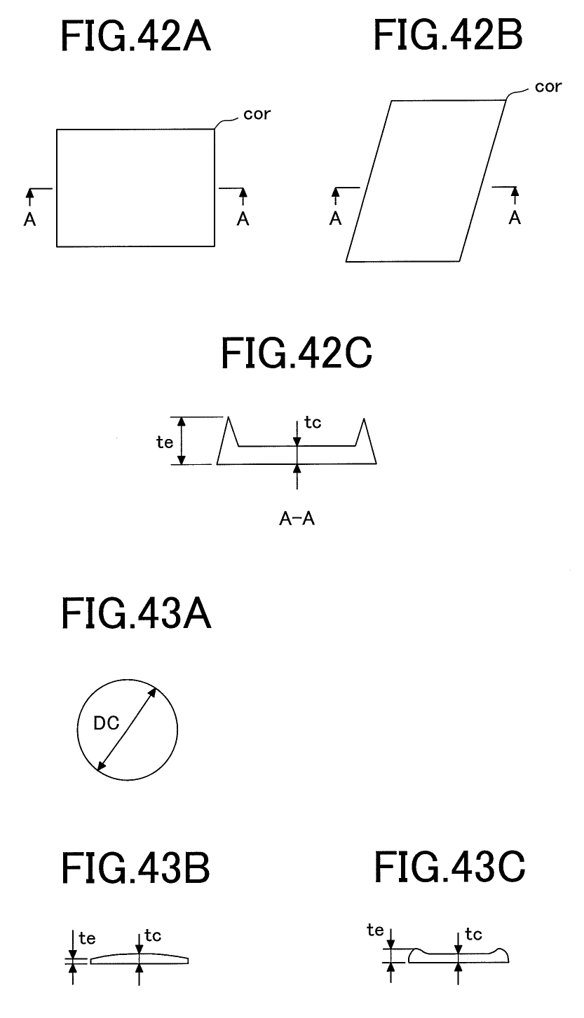

Meanwhile the plane shape and cross-sectional shape of the anode terminal 24 are also important for the withstand voltage characteristics of the FED. FIGS. 42A to 42C are examples of the outline of the anode terminal 24 and the cross-sectional shape thereof. The anode terminal 24 is formed by the printing method, and has been formed as a rectangular or a parallelogram, as shown in FIGS. 42A, 42B, due to the easiness of pattern formation. However, there is a problem with such shapes that the applied film is likely to be peeled off in the corner cor shown in FIGS. 42A, 42B. Also, the film thickness te of the end portion is larger than the film thickness tc of the central portion as shown in FIG. 42C, so that the film is likely to be peeled off. In addition, when the film thickness is further increased, the difference between the film thickness tc and the film thickness te is further increased, and the film becomes easily peeled off. In conventional examples, the film thickness tc of the central portion is often twice the film thickness te of the end portion.

In the embodiment, as shown in FIG. 43A, the outline of the anode terminal 24 is a circle with the diameter DC in order to prevent the peeling of the anode terminal 24. It is needless to say that the shape of the anode terminal 24 is not limited to a circle, and may be an ellipse. The possibility of the film peeling is reduced if there is no shape edge. FIG. 43B shows an ideal cross-sectional shape of the anode terminal 24 in which the film thickness te of the end portion is smaller than the film thickness tc of the central portion. When it is difficult to form such a cross-sectional shape, as shown in FIG. 43C, the film thickness te of the end portion is preferably set to a range of about 1.5 times the center film thickness tc. Alternatively, given the average film thickness tm of the anode terminal 24, the film thickness of the end portion is preferably set to 1.5 times the average film thickness tm or less.

Realization of the cross-sectional shapes as shown in FIGS. 43B, 43C, is difficult when the film thickness of the anode terminal 24 is increased. On the other hand, excessively thin film has a problem with the mechanical strength to the contact spring, as well as the heat resistance for the case of heat generated in the terminal. In the embodiment, the film thickness of the anode terminal 24 is set to a range of 5 μm to 30 μm, preferably 5 μm to 25 μm. In this way, it is possible to define the shape capable of preventing the peeling-off while avoiding the problem of the mechanical strength and heat generation in the anode terminal 24

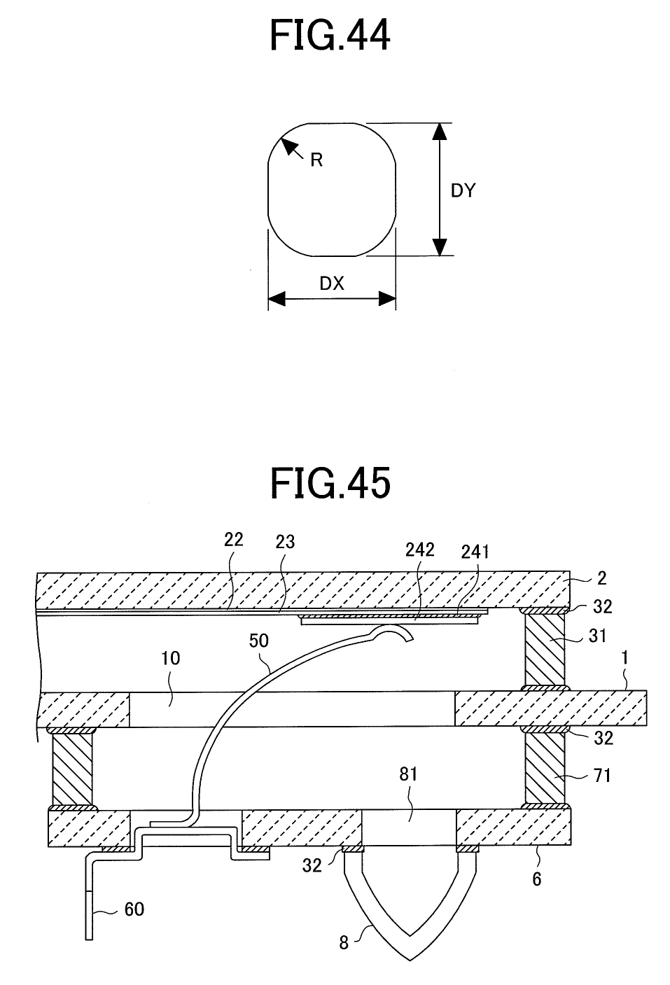

FIG. 44 is an example that the outline of the anode terminal 24 is a square or rectangular with rounded corners. In FIG. 44, the side lengths DX, DY are 10 mm each. Although the corner R is not so large, an effect can be obtained. It is possible to obtain a sufficient effect, for example, when the corner R is 1 mm or more. The most preferred cross-sectional shape is of FIG. 43B, similarly to the case in FIGS. 43A to 43C. However, when it is difficult to produce such a shape, as shown in FIG. 43C, the film thickness of the end portion is preferably 1.5 times the center film thickness or less. Alternatively, given the average film thickness tm of the anode terminal 24, the film thickness te in the end portion is preferably 1.5 times the average film thickness tm.

As described above, the V frit is typically divided into two types, insulating and conductive. In the embodiment, both the insulting V frit and the conductive V frit can be used. This is because the silver particles or silver flakes dispersed in the V frit, contribute to the conduction between the contact spring and the metal back. It may be thought that the conductive V frit would be used instead of dispersing silver particles or silver flakes. However, the conduction resistance varies due to the thin film of alumina Al₂O₃ that is actually produced on the surface of the metal back by the influence of the V frit. For this reason, it is necessary to disperse the silver particles or silver flakes even in the case of using the conductive V frit.

As described above, according to the embodiment, the anode terminal 24 is formed using the silver paste containing non-lead frit glass. Thus, it is possible to prevent the environmental contamination of lead, and to supply a high voltage in a stable manner. Further, since the peeling of the anode terminal 24 is prevented, the deterioration of the withstand voltage characteristics of the FED can be prevented.

The shape of the contact spring is not limited to as shown in FIG. 26. The embodiment can also be applied to the contact spring with the shape shown in FIGS. 29 and 30.

### Second Embodiment

The first embodiment is an example of the use of the V frit with silver particles or silver flakes dispersed therein, as the anode terminal 24. However, the anode terminal 24 is not limited to the V frit, and may be formed using a silver paste in which conductive particles or other particles are dispersed in a lead-based frit. In this case also, the spring material such as the contact spring contacts the anode terminal 24. At this time, the contact spring or other spring material may be bonded to the conductive frit, unless the conductive frit is sufficiently baked. When the contact spring is bonded to the anode substrate by the frit glass, the anode substrate may be destroyed in the bonded portion.

That is, Inconel or other material of the contact spring has a different thermal expansion coefficient from that of the glass, so that distortion is added to the anode substrate during the process when the contact spring is bonded by the frit glass, and the glass is cracked. The present embodiment addresses this problem.

In the embodiment, the plan view as the display device is also the same as FIG. 1. FIG. 45 is a B-B cross-sectional view of FIG. 1, which shows a substantial portion of the embodiment. The black matrix 22 and the metal back 23 are superimposed on the anode substrate, in a similar way to the first embodiment. On the metal back 23, an anode terminal 242 of a disk-shaped metal is bonded through a silver paste for bonding 241. The contact spring contacts the metal anode terminal 242. Thus, there is no possibility that the contact spring would be bonded to the glass substrate by the frit glass.

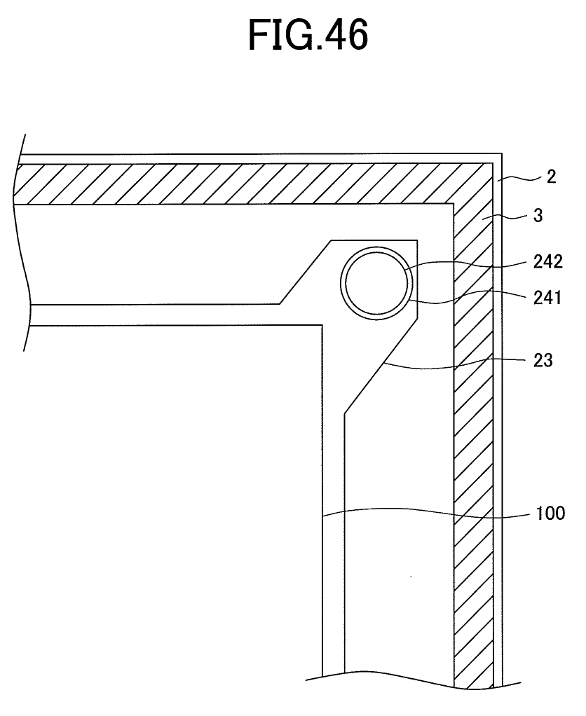

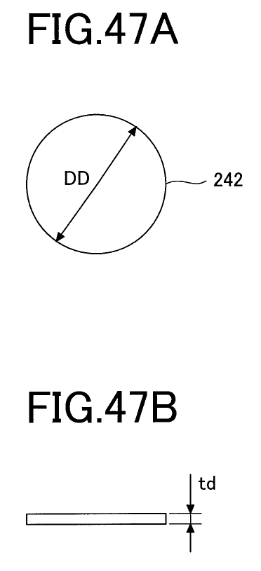

FIG. 46 is a schematic plan view in the vicinity of the anode terminal according to the embodiment. The basic configuration in FIG. 46 is the same as in FIG. 26. FIG. 46 is different from FIG. 26 in that the silver paste for bonding 241 is first applied to the metal back extending in the corner portion, and then the disk-shaped metal anode terminal 242 is bonded thereto. The contact spring 50 is designed to contact the metal anode terminal 242. FIGS. 47A, 47B show the shape of the metal anode terminal 242. The diameter DD of the metal anode terminal 242 is 20 mm or less, preferably 10 mm or less. The plate thickness td is 0.5 mm or less, preferably 0.2 mm or less. The thermal expansion coefficient of the metal anode terminal 242 is important. The material used for the metal anode terminal 242 has the same thermal expansion coefficient as that of the anode substrate which is the glass substrate. In the embodiment, the alloy of 52% Fe and 48% Ni is used. It is needless to say that the material is not limited to the Fe—Ni alloy, and any metal such as Kovar can be used as long as the thermal expansion coefficient is equal the glass.

The frit in which the silver particles and the like are dispersed to bond the meal anode terminal 242 is not so limited. However, by taking into account the environmental impact, frit glass not containing lead is preferred. From this point, it is preferred to use the silver paste, as described in the first embodiment, in which the silver particles or silver flakes dispersed. In this case also as described in the first embodiment, the V frit is formed as thin as possible within the limit necessary for bonding. This is for preventing the V frit from being peeled off.

In FIG. 46 and other figures, the metal anode terminal 242 has a circular shape. The circular shape is the most advantageous to the stress due to the difference between the thermal expansion coefficients of the glass and the metal anode terminal 242. However, it is needless to say that the shape is not limited to a circle but may be an ellipse, a square, or a rectangle, depending on the setting position of the metal anode terminal 242 or other restrictions.

In the first and second embodiments, there has been described an example in which the silver particles or silver flakes are dispersed in the V frit, to use as the anode terminal or as an adhesive of the anode terminal portion. The reason why the V frit is used is to prevent environmental deterioration due to lead when the lead-based frit is used. The frit glass is used in many components, such as the frame 31 of the FED, and the sealing 32 of the high voltage introduction terminal 60 and the like. Thus, it is needless to say that the use of the V frit as the sealing 32 can prevent environmental deterioration. Incidentally, when the V frit is used as the sealing 32, there is no need to disperse the conductive particles such as silver particles and silver flakes.

The above description has focused on the use of the V frit as frit glass. However, the embodiment is not limited to the V frit, and can also be applied to the non-lead frit glass. In other words, the following features can similarly be applied to the non-lead frit glass other than the V frit. That is, an appropriate resistance value is set by dispersing silver particles and silver flakes in the frit glass, the anode terminal 24 is formed in a shape in which peeling-off or other damage is unlikely to occur, and the metal anode terminal 242 is used as an adhesive.

In the first and second embodiments, the high voltage introduction terminal 60 is provided in the exhaust plate 6. This is one example of the setting position of the high voltage introduction terminal 60. The high voltage introduction terminal 60 may be directly provided in the cathode substrate 1 according to the necessity. The basic configuration of the present embodiment is also applicable when the high voltage introduction terminal 60 is directly provided in the cathode substrate.

### Fourth Example

### First Embodiment

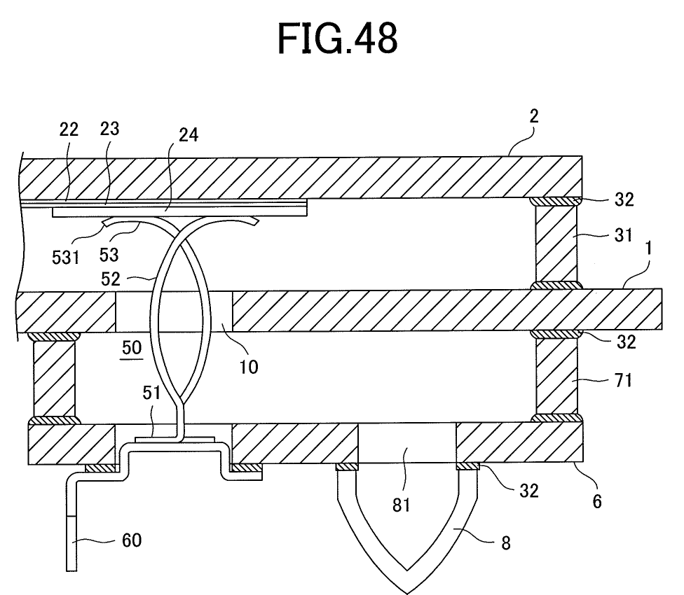

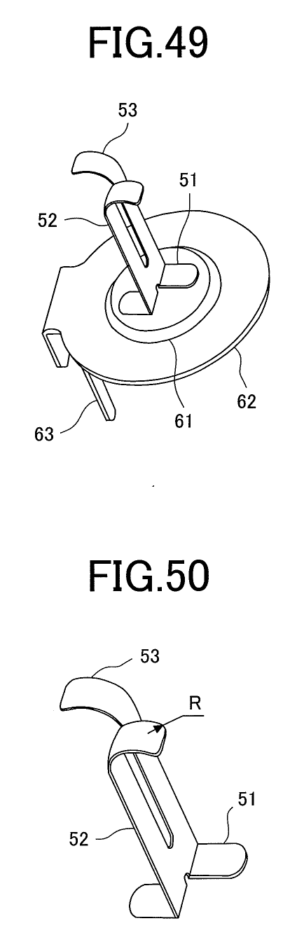

FIG. 48 is a B-B cross-sectional view of FIG. 1. FIG. 48 is the same as FIG. 29 except the base portion of the contact spring, so that the description is omitted. FIG. 49 is a perspective view showing the state in which the high voltage introduction terminal 60 and the contact spring 50 are connected by spot welding. In FIG. 49, the high voltage introduction terminal 60 includes: the flat portion 61 to which the contact spring 50 is spot welded; the sealing portion 62 sealed to the exhaust plate 6 by the sealing 32; and the external terminal 63 to be connected to the external power source.

FIG. 50 shows the shape of the contact spring 50 according to the embodiment. The contact spring 50 is formed of Inconel which can easily be spot welded to the Fe—Ni alloy. The contact spring 50 includes: the base portion 51 connected to the high voltage introduction terminal 60; the arm portion 52 for providing a spring force; and the contact portion 53 connected to the anode terminal 24 of the anode substrate 2.

Upon bending of the arm portion 52 of the contact spring 50, a bending stress is applied to the contact portion 53 of the contact spring 50. Then the contact portion 53 of the contact spring 50 contacts the anode terminal 24 formed in the anode substrate 2 with an appropriate force. In the embodiment, the contact pressure of the contact spring 50 is about 10 g, which may be larger than 10 g due to irregularity of parts. The contact portion 53 of the contact spring 50 is an appropriate curve, such as a sphere, able to stably contact the metal back 23.

Inconel, which is the material of the contact spring 50, has an appropriate spring force and heat resistance. The FED is subjected to heating process at a temperature of 400° C. or more, in sealing process, exhaust process or other processes. Thus, the heat resistance is an important issue. In the embodiment, the thickness of Inconel is set to 0.09 mm in order to provide an appropriate spring force. Although the Inconel material is 0.1 mm thick, the thickness is reduced to 0.09 mm by chemical polishing of the contact spring 50, which will be described below.

In FIG. 48, the contact spring 50 is applied with a high voltage of 8 KV to 10 KV. The distance between the cathode substrate 1 and the anode substrate 2 is about 2.8 mm. The interior of the display device is a strong electromagnetic field. Further, the contact spring 50 contacts the anode substrate 2 through the through hole 10 formed in the cathode substrate 1. The contact portion 53 of the contact spring 50 has an end portion 531 that is closer to the cathode substrate 1 than the metal back and the like formed in the anode substrate 2. In this way, the contact spring 50, particularly the contact portion 53 is under strict conditions with respect to the withstand voltage characteristics.

As described above, a large electric field is applied to the contact spring 50, so that the shape of the contact spring 50 is important. Although the contact spring 50 is on the high voltage side, it has been observed that when a shape edge exists in the contact spring 50, particularly in the contact portion 53, a spark occurs in the edge portion. In the embodiment, as shown in FIG. 6, the spark is prevented by forming a radius in the end corners, particularly in the contact portion 53 of the contact spring 50.

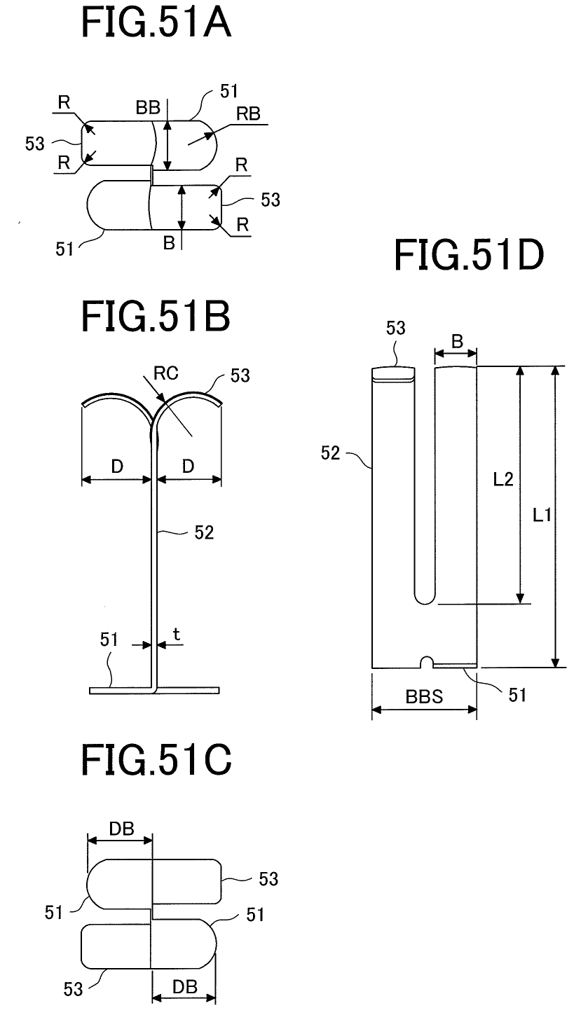

FIGS. 51A to 51D are detailed views of the contact spring 50 according to the embodiment. FIG. 51A is a plan view of the contact spring 50, FIG. 51B is a front view, FIG. 51C is a rear view, and FIG. 51D is a side view. In FIG. 51A, the radius is formed in the end corners of the contact portion 53 so as to remove sharp edges therefrom. Thus, the withstand voltage characteristics can be improved. In FIG. 51A, the width B of the contact portion 53 is 2 mm. In FIG. 51A, when the curvature radius R in the end corners of the contact portion 53 is set to 0.2 mm or more, preferably 0.5 mm or more, the withstand voltage characteristics are significantly improved. When the curvature radius R of the end corners is set to 1.0 mm or more, a more preferable result can be obtained for the withstand voltage characteristics.

The withstand voltage characteristics can also be improved by providing a curvature in the end of the base portion 51 shown in FIG. 51A. The curvature radius RB in the corner of the base portion 51 is about 1.2 mm. The width BB of the base portion 51 of the contact spring 50 is 2.35 mm which is slightly larger than the width B of the arm portion 52. By forming RB in the base portion 51, it is possible to prevent deformation or other damage of the end portion 531, which is advantageous for the withstand voltage characteristics.

In FIG. 51B, the end of the contact portion 53 of the contact spring 50 is a sphere whose curvature radius RC is 2 mm. The curvature radius RC of the contact portion 53 is determined by taking into account the contact area to the anode terminal 24, the contact pressure to the anode terminal 24 by the spring force from the arm portion 52 of the contact spring 50, or other factors. The diameter D in the horizontal direction of the contact portion 53 is 3.4 mm. When the contact spring 50 contacts the anode terminal 24, the arm portion 52 bends and D shown in FIG. 51B is increased. The plate thickness t of the material of the contact spring 50 is 0.1 mm, but is finally reduced to 0.09 mm by chemical polishing.

In FIG. 51C, the diameter DB in the horizontal direction of the base portion 51 is 3.1 mm. The curvature radius in the end of the base portion 51 and of the contact portion 53 is the same as described in FIG. 51A.

In FIG. 51D, the height of the contact spring 50 is 14 mm. When the contact spring 50 is inserted into the FED, the arm portion 52 of the contact spring 50 bends and L1 is reduced. The arm portion 52 is divided into two parts for increasing the reliability of the contact. The width B of the arm portion 52 is 2 mm, and the length L2 is 11 mm. The spring force is determined by the length L3 and width B of the arm portion 52.

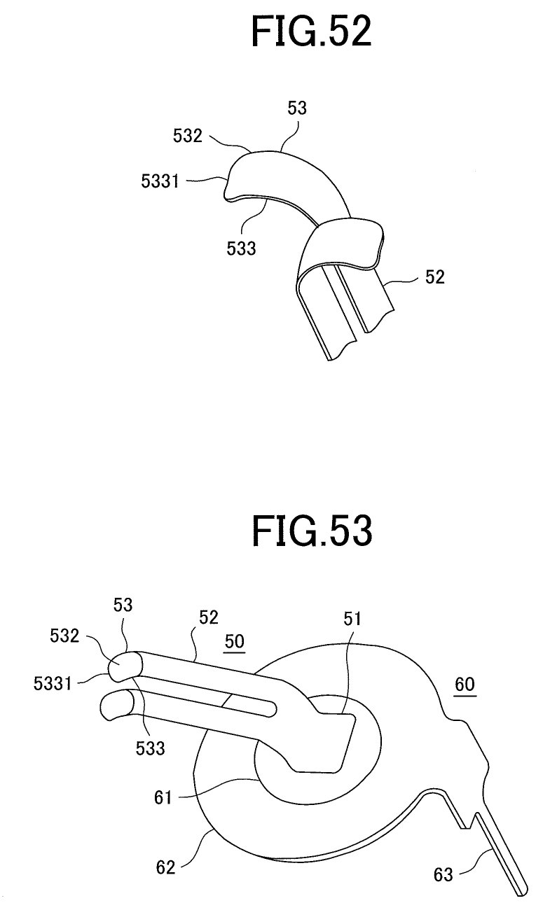

FIG. 52 is an enlarged view of the contact portion 53 of the contact spring 50. As described above, the large electric field is present around the contact spring 50. Thus, a sharp projection can cause a spark in the contact spring 50. The Inconel material with the thickness of 1 mm is punched out by press molding before bending to form the contact spring 50. If a burr or other defect occurs in a side portion 533 by press molding, the damaged portion can cause a spark.

While the contact portion 53 of the contact spring 50 has a contact surface 532 that contacts the anode terminal 24. If the contact surface 532 has a projection, the contact with the anode terminal 24 is a point contact and is unstable. In this case, the electric current concentrates at the point contact portion, which is then excessively heated, and a problem of reliability arises.

Further, when the contact portion 53 having a projection contacts the anode terminal 24, the anode terminal 24 is shaved by the projection, and shaving particles arise in the FED. The particles cause a significant problem with respect to the withstand voltage characteristics. For this reason, the contact surface 532 of the contact portion 53 should be a flat surface without any projection or raised portion. In addition to the projection, a dent or scratch also makes a sharp edge and causes the same problem.

Meanwhile, Inconel, which is the material of the contact spring 50, is likely to be scratched or damaged even in the material stage. The Inconel material is also likely to be scratched or damaged in the stages such as press molding and bend forming.

The embodiment solves the above problems in such a way that the surface of the contact spring 50 is made flat by applying chemical polishing after processing and molding of the contact spring 50. A flat surface is obtained by chemical polishing in which projections or raised portions are more polished by a local battery effect. In the embodiment, the surface roughness Rmax is set to 0.6 μm or less, particularly for the side portions 533 of the contact portion 53 in the contact spring 50 after chemical polishing. Of the side portions 533, an end side portion 5331 of the contact portion 53, in particular, has a large effect on the voltage resistance. For this reason, even if the surface roughness Rmax may not be set to 0.6 μm or less for the entire side portions 533, it is possible to achieve an effect by setting the Rmax at 0.6 μm or less, at least for the end side portion 5331.

Further, the flatness of the contact surface 532 of the contact portion 53 of the contact spring 50 is set to a surface roughness Rmax of 0.6 μm or less. Here, unlike the arm portion 52, the contact surface 532 of the contact portion 53 has a curvature. Although the arm portion 52 has a curvature due to the bending of the contact spring 50 when mounted in the display device, it is clearly different from the curvature of the contact portion 53. By setting the surface roughness of the contact surface 532 at 0.6 μm or less, it is possible to prevent the anode terminal 24 from being shaved. As a result, the spark due to the shaving particles can be prevented.

Here, Rmax 0.6 μm is defined as follows. That is, the length of 0.25 mm is optionally specified in the contact portion 53 of the contact spring 50. The range is measured by a surface roughness meter to calculate the surface roughness. The difference between the highest convex portion and the lowest concave portion is denoted by Rmax, relative to the average value of the surface roughness. The surface roughness may be evaluated by other method such as Rz, but Rmax is the most appropriate evaluation method for the present example.

With the configuration of the embodiment, it is possible to significantly reduce the spark occurring from the contact spring 50. It is also possible to prevent the production of the unwanted particles in the display device. Thus, the withstand voltage characteristics can also be improved.

### Second Embodiment

FIG. 53 shows the shape of another contact spring in a second embodiment.

The material of the contact spring 50 is Inconel having a thickness of 0.1 mm. The plate thickness is adjusted to 0.09 mm by electro polishing. As shown in FIG. 53, the arm portion 52 of the contact spring 50 is divided into two parts, ensuring a safe contact with the anode terminal 24. Further, the shape of the high voltage introduction terminal 60 to which the contact spring 50 is spot welded, is the same as described in the first embodiment.

In the embodiment, the contact pressure is determined by the bending stress of the arm portion 52 of the contact spring 50. The bending stress is proportional to the width of the contact spring 50, proportional to the amount of the bending, inversely proportional to the length of the contact spring 50, and proportional to the third power of the plate thickness of the contact spring 50. These properties further facilitate the evaluation of the contact pressure. The bending stress of the contact spring 50 is dominated by the shape of the arm portion 52 near the base portion 51.

In the present embodiment, similarly to the first embodiment of FIG. 7, the shape of the contact portion 53 of the contact spring 50 can prevent the spark, by setting the radius of the corners at 0.2 mm or more, preferably 0.5 mm or more, and more preferably 1.0 mm or more.

Further, in the embodiment, it is also possible to improve the withstand voltage characteristics by setting the surface roughness at a predetermined value or less, for the side portions 533 of the contact portion 53 of the contact spring 50, as well as for the surface contacting the anode terminal 24. In other words, the surface roughness Rmax is set to 0.6 μm or less for the contact part 532 of the contact portion 53 of the contact spring 50, which contacts the anode terminal 24. Similarly, the surface roughness Rmax is set to 0.6 μm or less for the side portions 533 of the contact portion 53. Even if the surface roughness Rmax may not be set to 0.6 mm or less for the entire side portions 533 of the contact portion 53, it is possible to improve the withstand voltage characteristics by setting the Rmax at 0.6 mm or less, for the end side portion 5331 of the contact portion 53. In the embodiment, the contact portion 53 of the contact spring 50 largely slides on the surface of the anode terminal 24. Thus, it is particularly important that the surface roughness Rmax is set to a predetermined value or less for the end side portion 5331 of the contact portion.

The definition of Rmax is the same as described in the first embodiment. Such a surface can be obtained when the contact spring 50 is electro-polished. With the contact spring 50 of the embodiment, it is possible to obtain a high voltage introduction system capable of accurately controlling the contact pressure with excellent withstand voltage characteristics.

### Third Embodiment

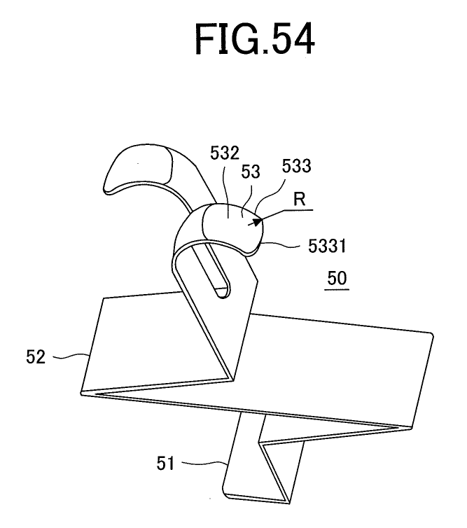

FIG. 54 is a perspective view showing still another example of the contact spring according to a third embodiment. Also in the embodiment, the contact portion 53 of the contact spring 50 is divided into two parts so that the bending stress of the Z-shaped portion is evenly distributed. In FIG. 54, the contact spring 50 is formed of Inconel having a thickness of 0.1 mm, in a similar way to the first embodiment. Subsequently, the surface roughness is reduced while the plate thickness is reduced to 0.09 mm by electro polishing.

The width of the contact spring 50 is 5 mm, the width of the each of the two divided parts of the arm portion 52 is 2 mm, and the gap between the two divided parts of the arm portion is 1 mm. The high voltage introduction button 60 is formed of the Fe—Ni alloy in a similar way to the first embodiment. In FIG. 54, unlike the other portions, the contact portion 53 of the contact spring 50 is a curve having a small curvature radius.

In the embodiment, the contact pressure of the contact spring 50 is mainly determined by the arm portion 52 bending in Z shape. Such a Z shaped arm portion can reduce the distance at which the contact portion 53 of the contact spring 50 slides on the anode terminal surface. As a result, the possibility of the production of shaving particles of the anode terminal 24 can be further reduced. In addition, the Z shaped arm portion 52 further facilitates the control of the contact pressure.

Also in the embodiment, similarly to the first embodiment in FIG. 51, the shape of the contact portion 53 of the contact spring 50 can prevent the spark by setting the radius of the corners at 0.2 mm or more, preferably 0.5 mm or more, and more preferably 1.0 mm or more.

Further, in the embodiment, it is also possible to improve the withstand voltage characteristics by setting the surface roughness at a predetermined value or less, for the side portions 533 of the contact portion 53 of the contact spring 50, as well as for the surface contacting the anode terminal 24. In other words, the surface roughness Rmax is set to 0.6 μm or less for the contact part 532 of the contact portion 53 of the contact spring 50, which contacts the anode terminal 24. Also, the surface roughness Rmax is set to 0.6 μm or less for the side portions 533 of the contact portion 53.

Even if the surface roughness Rmax may not be set to 0.6 μm or less for the entire side portions 533 of the contact portion 53, it is possible to improve the withstand voltage characteristics by setting the Rmax at 0.6 μm or less for the end side portion 5331 of the contact portion 53. The definition of Rmax is the same as described in the first embodiment. Such a surface can be obtained when the contact spring 50 is electro-polished.

As described above, with the contact spring 50 of the embodiment, it is possible to obtain a high voltage introduction system capable of reliably preventing the anode terminal 24 from being shaved, and providing easy control of the contact pressure with excellent withstand voltage characteristics.

### Fifth Example

### First Embodiment

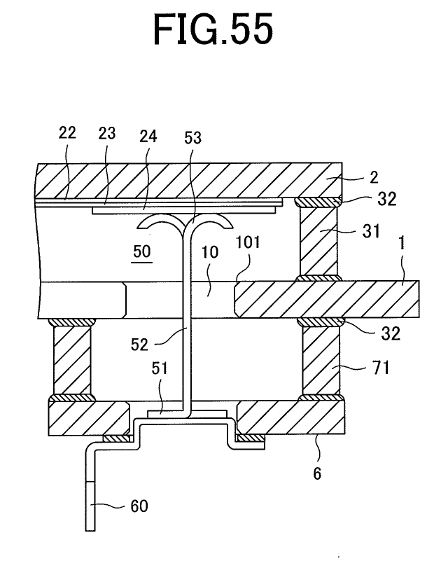

FIG. 55 is a B-B cross-sectional view of FIG. 1. In FIG. 55, the contact spring 50 has the same shape as described in FIGS. 49, 50, and 51. Further, the configuration of FIG. 55 is the same as the configuration of FIG. 29 expect that there is no exhaust hole. Thus, the detailed description is omitted.

The contact spring 50 is applied with a high voltage of 8 KV to 10 KV. The distance between the cathode substrate 1 and the anode substrate 2 is about 2.8 mm. The interior of the display device is a strong electrical field. Further, the contact spring 50 contacts the anode substrate 2 through the through hole 10 formed in the cathode substrate 1. The contact portion 53 of the contact spring 50 has an end portion that is closer to the cathode substrate 1 than the metal back and the like formed in the anode substrate 2. In this way, the contact spring 50, particularly the contact portion 53 is under strict conditions with respect to the withstand voltage characteristics.

As described above, a large electric field is applied to the contact spring 50, so that the shape of the contact spring 50 is important. Although the contact spring 50 is on the high voltage side, it has been observed that when a shape edge exists in the contact spring 50, particularly in the contact portion 53, a spark occurs in the edge portion. In the embodiment, as shown in FIG. 50, the spark is prevented by forming a radius in the end corners, particularly in the contact portion 53 of the contact spring 50.

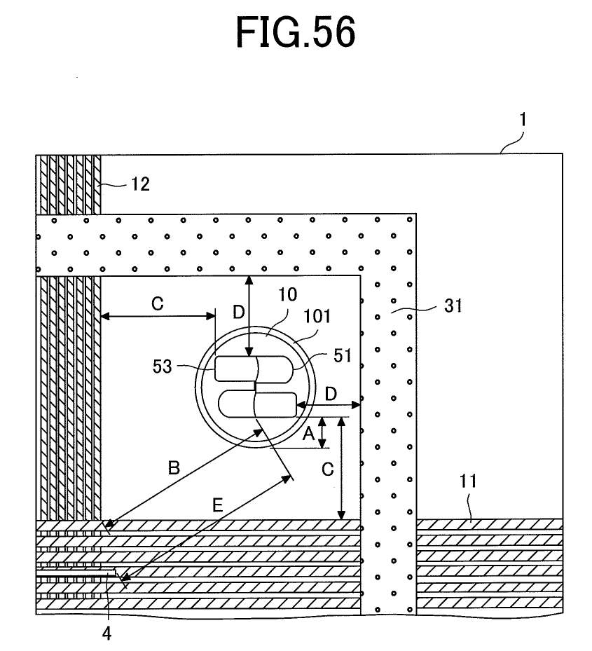

FIG. 56 is an enlarged view of a corner portion of the cathode substrate 1, in which the contact spring 50 passes through the through hole in the cathode substrate 1. FIG. 56 is a plan view of the contact spring 50 seen from the top. The inside of the cathode substrate 1, there is provided the frame 31 for sealing the cathode substrate 1 and the anode substrate 2 through the sealing 32. The distance between the cathode substrate 1 and the anode substrate 2 is 2.8 mm. The inside of the frame member 31 is evacuated to vacuum.

In FIG. 56, a large number of data signal lines 12 extend in the vertical direction of the screen. The data signal lines 12 extend through under the frame 31 to the outside, and receive data signals from the outside. Also in FIG. 56, a large number of scan lines 11 extend in the horizontal direction of the screen. The scan lines 11 extend through under the frame 31 to the outside, and receive scan signals. There is formed an insulating layer between the data signal lines 12 and the scan lines 11.

The through hole 10 is formed in an inside corner portion of the frame 31. The contact spring 50 passes through the through hole to contact the anode terminal formed in the anode substrate not shown. In the embodiment, the diameter of the through hole is 10 mm. The through hole has a chamfer 101 formed around the periphery thereof. The contact spring 50 is applied with a high voltage of 8 KV to 10 KV which is the anode voltage. While the data signal lines 12 or the scan lines 11 formed in the cathode substrate 1 are applied with a very small voltage, which is close to the ground potential rather than the anode voltage. As a result, a strong electrical field is applied between the contact spring 50 and the components formed in the cathode substrate 1, in which a spark is likely to occur.

The cathode substrate 1 has a glass surface or a surface of an insulating film, except the portions in which the data signal lines 12 or the scan lines 11 are formed. The surface of the insulating material is likely to be charged, and the potential is unstable. Thus, a spark is likely to occur with respect to the contact spring 50. Particularly because electrons are emitted from the electron sources 13 during FED operation, the problem of the spark due to charging is significant. Further, the surface around the through hole 10 through which the contact spring 50 passes is also an insulating surface in which a spark is likely to occur. However, when the distance A in FIG. 56 between the contact spring 50 and an end of the through hole, is set to 1.5 mm or more, it is possible to dramatically reduce the spark in the vicinity of the contact spring 50 and the through hole. Increasing the through hole poses a problem with respect to the mechanical strength. Meanwhile an excessive reduction of the contact spring 50 could diminish the reliability of the contact between the contact spring 50 and the anode. For this reason, the fact that the spark can be significantly reduced by ensuring the distance of 1.5 mm is very important to realize the FED.

In the FED, the electron emission sources 13 are formed in the vicinity of the data signal lines 12 and the scan lines 11. The potential of the electron source 13 is equal to the potential of the scan line 11. Generally, the potential of the scan line 11 is vanishingly small compared to the anode potential. Thus, generally the difference between the potentials of the electron source 13 and the contact spring 50 is equal to the anode voltage. When a spark occurs between the electron source 13 and the contact spring 50, the electron source 13 is destroyed, causing a partial failure in the FED screen. For this reason, the spark between the electron source 13 and the contact spring 50 should be avoided as much as possible. When the distance B in FIG. 56 between the contact spring 50 and the electron source is set to 10 mm or more, the spark between the electron source 13 and the contact spring 50 can be reduced to almost zero. The value 10 mm is large when considering the fact that the distance between the anode substrate 2 and the cathode substrate 1 is 2.8 mm. However, it is necessary to ensure such a large value to prevent the spark between the contact spring 50 and the electron source 13. The embodiment is important in that it is necessary to provide the distance directly from the electron source 13.

The data signal is applied to the data signal line 12, and the scan signal is applied to the scan line 11. The potential of both signals is almost the ground potential rather than the anode voltage. For this reason, the spark between the data signal line 12 and the scan signal line 11 is also a significant problem. It has been found by the experiments that it is possible to dramatically reduce the spark between the contact spring 50 and the data signal line 12 or the scan line 11, by setting the distance C at 6.5 mm or more between the contact spring 50 and the data signal line 12 or the scan line 11.

The frame 31 is also formed of an insulating material, generally glass, to seal the cathode substrate 1 and the anode substrate 2 while maintaining the distance between the cathode substrate 1 and the anode substrate 2. Thus, the frame 31 is also charged during FED operation. Since the frame 31 is the insulating material, the charge state of the surface is unstable. As a result, a spark is likely to occur between the contact spring 50 and the frame 31. Meanwhile the display area of the FED can be increased, by providing the through hole in the vicinity of the frame 31 and by providing the contact spring 50 in the vicinity of the frame 31. However, if the contact spring 50 is provided in the vicinity of the frame 31, a spark occurs between the contact spring 50 and the frame 31. When the distance D in FIG. 56 between the contact spring 50 and the frame 31, is set to 5 mm or more, the spark between the contact spring 50 and the frame 31 can be reduced to almost zero. The value of 5 mm is large when considering the fact that the distance between the anode substrate 2 and the cathode substrate 1 is 2.8 mm. However, it is necessary to ensure such a large value to prevent the spark between the contact spring 50 and the frame 31.

In the FED, the spacers 4 are used for maintaining the distance between the cathode substrate 1 and the anode substrate 2 against the atmosphere. The spacer 4 is provided on the scan line so as not to hinder the image formation. The surface of the spacer is given a small conductivity to prevent the spacer 4 from being charged, and a small current flows through the spacer 4 during FED operation. Thus, the spacer 4 on the anode side has almost the anode potential. The cathode side has the potential of the scan line 11, which is almost the earth potential rather than the anode potential. For this reason, the difference between the potentials of the contact spring 50 and the spacer 4 is larger on the cathode side than on the anode side. In the embodiment, by setting the distance between the contact spring 50 and the spacer 4 in particular on the cathode side at 10 mm or more, the spark between the contact spring 50 and the spacer 4 can be reduced to almost zero.

In the contact spring 50, as shown in FIGS. 51A to 51D, the radius is formed in the corners so as to remove sharp edges from the end of the contact spring. Or the contact spring 50 is chemically polished so as to remove sharp edges from the end thereof. With this configuration, it is possible to prevent the spark between the contact spring 50 and the peripheral construction.

FIG. 55 shows the case in which no exhaust hole is provided in the vicinity of the contact spring. However, the embodiment can also be applied when the exhaust hole is present in the vicinity of the contact spring as shown in FIG. 29.

### Second Embodiment

The first embodiment discloses the configuration to prevent the spark between the contact spring 50 and the peripheral construction. Meanwhile, the anode substrate 2 can also be a cause of a spark. The anode substrate 2 is mainly the display area 100 in which the phosphors 21 or other components are formed. The BM 22 or the metal back 23 extends to the periphery of the anode substrate 2. The configuration in the layer direction of the anode substrate 2 is the same as described in FIG. 3. The second embodiment prevents a spark from occurring by a configuration of the planer anode substrate 2.

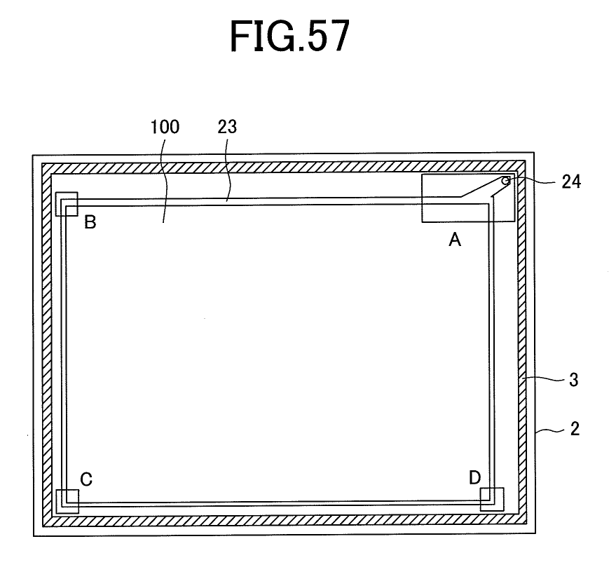

FIG. 57 is a plan view showing the inside of the anode substrate 2. In FIG. 57, the BM 22 and the metal back 23 are shown surrounding the display area 100. In the embodiment, it is assumed that the BM 22 and the metal back 23 are formed in the same area, so that only the metal back 23 is shown in FIG. 57 and other figures. If the BM 22 is formed beyond the metal back 23, the term “metal back 23” should be replaced with the term “BM 22” in the following description.

In the upper right corner portion of FIG. 57, the metal back 23 extends about the sealing portion 3 in order to contact the contact spring 50. The anode terminal is formed on the metal back 23 extending in the upper right corner portion. The configuration of the anode terminal is the same as described in the first embodiment. The metal back is surrounded by a glass surface which is the insulating material. The glass surface is charged and its potential is unstable during the operation. The sealing portion 3 is formed around the metal back 23 in order to seal the anode substrate 2 and the cathode substrate 1.

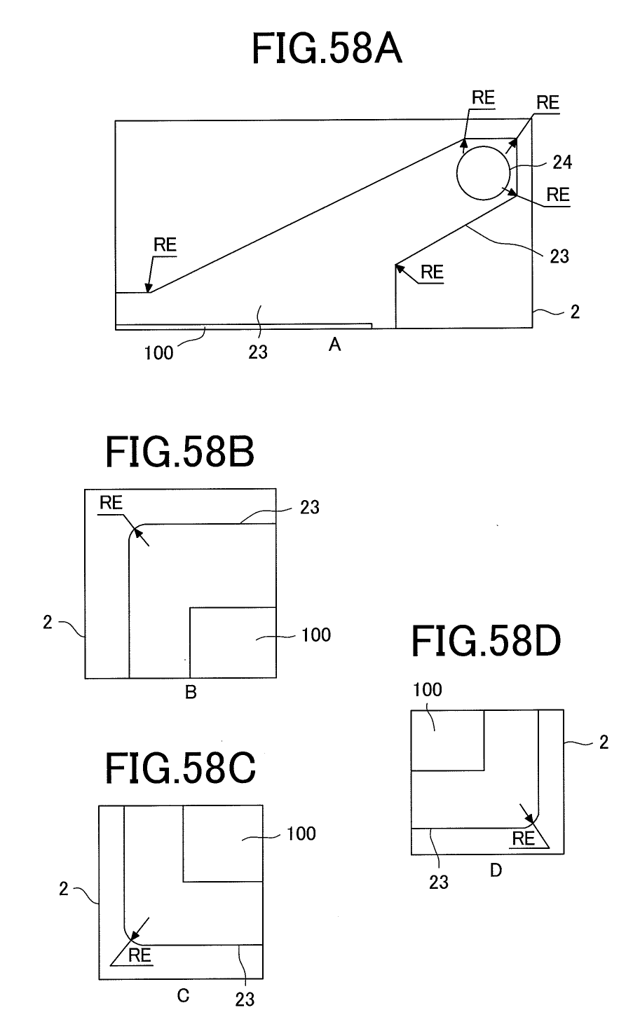

FIG. 39 shows the configuration in the upper right corner portion of FIG. 57, according to the conventional configuration. In FIG. 39, the anode terminal 24 is formed on the metal back 23 extending in the corner portion. As shown in FIGS. 58A to 58D, the corner portion of the metal back 23 has a shape angle. When such an angular portion is formed in the metal back 23, a spark occurs between the peripheral charged glass portion and the metal back 23. Traditionally it has been thought that a spark is caused by a sharp edge on the cathode side. However, in the display device driven by electrons, such as the FED, a sharp edge on the anode side has also an effect on the occurrence of a spark, due to the charge generated on the glass surface.

The embodiment prevents the spark due to the metal back 23 by forming the radius in the peripheral corners of the metal back 23. FIGS. 58A to 58D are views showing the shape of the metal back 23 according to the embodiment. FIG. 58A shows the A portion in the upper right of FIG. 57. FIG. 58B shows the B portion in the upper left of FIG. 57. FIG. 58C shows the C portion in the lower left of FIG. 57. FIG. 58D is an enlarged view of the lower right portion of FIG. 57. As shown in FIGS. 58A to 58D, the corner radius RE is formed in all the corners of the metal back 23. The value of RE is 0.5 mm or more, preferably 1 mm or more. Preferably RE is formed not only in the edge in the vicinity of the anode terminal 24, but also in all the other corner edges formed in the periphery of the metal back as shown in FIGS. 58A to 58D.

The metal back 23 is formed by sputtering or evaporation. It is possible to form RE in the corner edges as shown in FIGS. 58A to 58D, by appropriately setting the sputtering or evaporation mask.

The above description has been made assuming that the metal back 23 is formed in the same area of the BM 22, or is formed beyond the BM 22. However, when the BM 22 is formed beyond the metal back 23, the radius RE of the corner edges of the BM 22 is set to 0.5 mm or more, preferably 1 mm or more. The BM 22 has a two-layer structure of a chrome layer and a chrome oxide layer, in which the chrome oxide layer is covered with the chrome layer. The BM 22 is formed by photoetching, so that it is easy to form the radius in the corner edges thereof.

### Third Embodiment

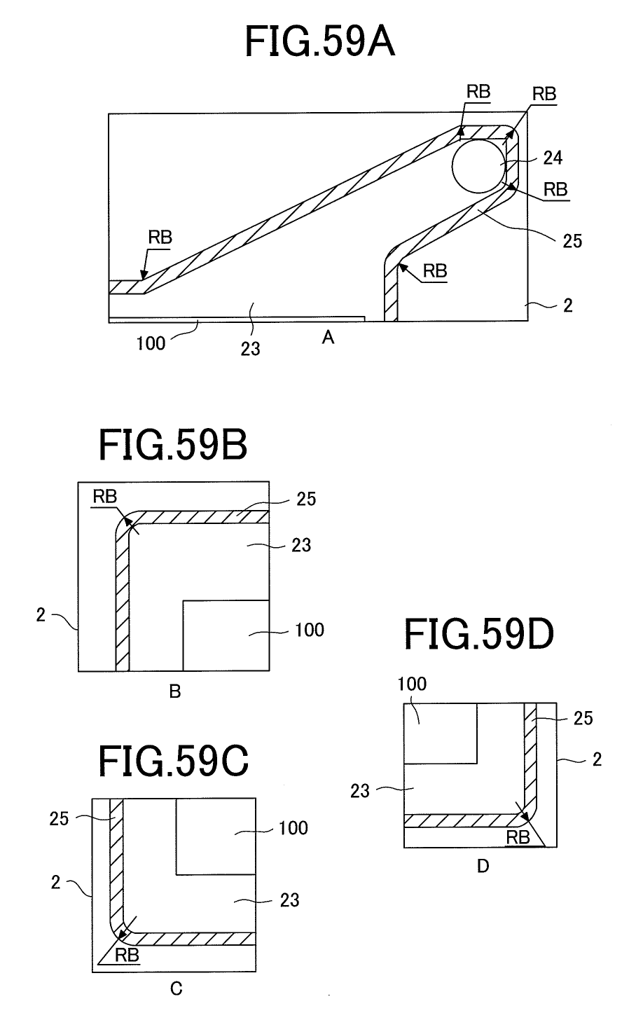

FIGS. 59A to 59D show a third embodiment of the present example. The metal back 23 is formed of aluminum which is a metal. In the example of FIGS. 58A to 58D, the end portions of the metal film are adjacent to the glass surface, so that the surface resistance greatly varies. When the glass surface is charged, the potential difference with the metal back 23 is unstable, which triggers a spark.

In the embodiment, as shown in FIGS. 59A to 59D, a high resistance film 25 of iron oxide (colcothar) is applied to the periphery of the metal back. The high resistance film 25 is preferably applied to the whole circumference as shown in FIGS. 59A to 59D. With this configuration, the surface resistance varies gradually between the metal back 23 and the glass. As a result, even if the glass is charged during EFD operation, the electrical field in the end portions of the metal back is reduced by the high resistance film 25. Thus, the spark is prevented.

In this case, the electrical field is likely to be concentrated in the end portions of the high resistance film 25, with respect to the charged portion of the glass. In the embodiment, the high resistance film 25 has a curvature as the radius RB in the corners, in order to reduce the concentration of the electrical field. The value of RB is 0.5 mm or more, preferably 1 mm or more. Most preferably, the high resistance film 25 is formed around the whole circumference of the metal back. Even if the high resistance film 25 may not be applied to the whole circumference, it is possible to achieve an effect by applying the high resistance film only to the area shown in FIG. 59A.

The application of the high film resistance 25 can be performed by screen printing. With the screen printing method, it is easy to form a radius of about 0.5 mm in the corners. The above configuration has been described by assuming that the metal back 23 is formed in the same area of the BM 22, or that the metal back 23 is larger than the BM 22. When the range of the BM 22 is larger than the metal back 23, the term “metal back 23” should be replaced with the term “BM 22” in the foregoing description.

As described above, according to the embodiment, it is possible to doubly prevent the occurrence of the spark by not only the high resistance film 25, but also the formation of the curvature radius RB in the corners of the high resistance film 25.

What is claimed is:

1. A display device having an interior maintained at a vacuum, comprising:
a cathode substrate having electron emission sources arranged in a matrix form; and
an anode substrate facing the cathode substrate and having phosphors formed at positions corresponding to the electron emission sources, to which an anode voltage is applied,
wherein a high voltage introduction terminal is formed in the cathode substrate to supply the anode voltage,
wherein a contact spring is connected to the high voltage introduction terminal to contact the anode substrate,
wherein the contact spring has an arm portion for providing a bending stress, and a portion for contacting the anode substrate, and
wherein the portion of the contact spring to contact the anode substrate is formed by a curve having curvatures respectively in the length and width directions of the contact spring.

2. The display device according to claim 1,
wherein the curve of the portion of the contact spring to contact the anode substrate is a curve in which the curvature radius in the length direction of the contact spring is smaller than the curvature radius in the width direction thereof.

3. A display device having an interior maintained at a vacuum, comprising:
a cathode substrate having electron emission sources arranged in a matrix form; and
an anode substrate facing the cathode substrate and having phosphors formed at positions corresponding to the electron emission sources, to which an anode voltage is applied,
wherein an exhaust plate having an exhaust hole to evacuate the interior of the display device is attached to the cathode substrate,
wherein a high voltage introduction button is sealed to the exhaust plate to supply the anode voltage,
wherein a connection member is connected to the high voltage introduction button to provide electrical conductivity to the anode substrate, and
wherein the connection member contacts an anode terminal formed in the anode substrate.

4. The display device according to claim 3,
wherein the connection member is a contact spring.

5. The display device according to claim 3,
wherein the high voltage introduction button is sealed to the exhaust plate through a frit glass.

6. The display device according to claim 3,
wherein the high voltage introduction button is fused to the exhaust plate.

7. A display device having an interior maintained at a vacuum, comprising:
a cathode substrate having electron emission sources arranged in a matrix form; and
an anode substrate facing the cathode substrate and having phosphors formed at positions corresponding to the electron emission sources, to which an anode voltage is applied,
wherein a glass substrate is attached to the cathode substrate through a sealing portion,
wherein a high voltage introduction terminal is sealed to the glass substrate to supply the anode voltage,
wherein a connection member is connected to the high voltage introduction terminal to provide electrical conductivity to the anode substrate,
wherein the connection member is connected to an anode terminal formed in the anode substrate, and
wherein the anode terminal is a film in which silver particles and silver flakes are dispersed in a frit glass containing vanadium oxide as a main component.

8. The display device according to claim 7,
wherein the content of silver in the anode terminal is 60% by weight to 95% by weight.

9. The display device according to claim 7,
wherein, assuming that the total of the silver particles and the silver flakes is 100, the amount of the silver flakes is 50 or more.

10. A display device having an interior maintained at a vacuum, comprising:
a cathode substrate having electron emission sources arranged in a matrix form; and
an anode substrate facing the cathode substrate and having phosphors formed at positions corresponding to the electron emission sources, to which an anode voltage is applied,
wherein a high voltage introduction terminal is formed in the cathode substrate to supply the anode voltage,
wherein a contact spring is connected to the high voltage introduction terminal to contact the anode substrate,
wherein the contact spring has an arm portion for providing a bending stress, and a contact portion for contacting an anode terminal formed in the anode substrate, and
wherein a corner radius of 0.2 mm or more is formed in an end of the contact portion.

11. The display device according to claim 10,
wherein a corner radius of 0.5 mm or more is formed in an end of the contact portion.

12. A display device having an interior maintained at a vacuum, comprising:
a cathode substrate having electron emission sources arranged in a matrix form; and
an anode substrate facing the cathode substrate and having phosphors formed at positions corresponding to the electron emission sources, to which an anode voltage is applied,
wherein a high voltage introduction terminal is formed in the cathode substrate to supply the anode voltage,
wherein a contact spring is connected to the high voltage introduction terminal to contact the anode substrate,
wherein the contact spring has an arm portion for providing a bending stress, and a contact portion for contacting an anode terminal formed in the anode substrate,
wherein the surface roughness Rmax of a surface of the contact portion to contact the anode terminal is 0.6 μm or less, and
wherein the surface roughness Rmax of a side portion of the contact portion is 0.6 μm or less.

13. The display device according to claim 12,
wherein the surface roughness Rmax of an end side of the contact portion is 0.6 μm or less.

14. A display device having an interior maintained at a vacuum, comprising:
a cathode substrate having data signal lines provided in a second direction and extending in a first direction, scan lines provided in the first direction and extending in the second direction, and electron sources formed in the vicinity of the intersections of the data signal lines and the scan lines;
an anode substrate having phosphors provided at positions corresponding to the electron sources, a black matrix formed between the phosphors, and a metal back formed covering the phosphors and the black matrix;
a spacer formed between the cathode substrate and the anode substrate; and
a sealing frame for sealing the peripheries of the cathode substrate and the anode substrate,
wherein a high voltage introduction plate with a high voltage introduction terminal attached thereto is attached to the cathode substrate,
wherein a contact spring is attached to the high voltage introduction terminal,
wherein the contact spring is connected to the anode substrate through a hole formed in the cathode substrate, and
wherein the distance between the contact spring and an end of the hole formed in the cathode substrate is set to 1.5 mm or more.

15. The display device according to claim 14,
wherein the distance between the contact spring and the electron source is set to 10 mm or more.

16. The display device according to claim 14,
wherein the distance between the contact spring and the data signal line or the scan line is set to 6.5 mm or more.

17. The display device according to claim 14,
wherein the distance between the contact spring and the sealing frame is set to 5 mm or more.

18. The display device according to claim 14,
wherein the distance between the contact spring and the spacer is set to 10 mm or more.
